(19) United States
(12) Patent Application Publication
(10) Pub. No.: US 2018/0285644 A1
(43) Pub. Date: Oct. 4, 2018

(54) SENSOR INFORMATION PROCESSING METHOD AND SYSTEM BETWEEN VIRTUAL WORLD AND REAL WORLD

(71) Applicant: Electronics and Telecommunications Research Institute, Daejeon (KR)

(72) Inventor: Jin Young LEE, Seoul (KR)

(73) Assignee: Electronics and Telecommunications Research Institute, Daejeon (KR)

(21) Appl. No.: 15/939,775

(22) Filed: Mar. 29, 2018

(30) Foreign Application Priority Data
Mar. 29, 2017 (KR) 10-2017-0040250
Mar. 29, 2017 (KR) 10-2017-0040251
Mar. 31, 2017 (KR) 10-2017-0041542
Apr. 7, 2017 (KR) 10-2017-0045128
Apr. 7, 2017 (KR) 10-2017-0045129
Apr. 7, 2017 (KR) 10-2017-0045130
Mar. 29, 2018 (KR) 10-2018-0036866

(51) Int. Cl. G06K 9/00; G06K 9/62; G06T 19/00

(52) U.S. Cl. CPC G06K 9/00671; G06T 19/006; G06K 9/6288; G06K 9/0063

(57) ABSTRACT

Disclosed is a sensor information processing method and system. The sensor information processing method may include acquiring first sensing information from a sensor of the real world; converting the first sensing information into virtual world object characteristics applied to the virtual world or second sensing information applied to the virtual world; and applying the virtual world object characteristics or the second sensor information into the virtual world.

### CROSS-REFERENCE TO RELATED APPLICATION(S)

This application claims the priority benefit of Korean Patent Application No. 10-2017-0040250 filed on Mar. 29, 2017, Korean Patent Application No. 10-2017-0040251 filed on Mar. 29, 2017, Korean Patent Application No. 10-2017-0041542 filed on Mar. 29, 2017, Korean Patent Application No. 10-2017-0045128 filed on Apr. 7, 2017, Korean Patent Application No. 10-2017-0045129 filed on Apr. 7, 2017, Korean Patent Application No. 10-2017-0045130 filed on Apr. 7, 2017, and Korean Patent Application No. 10-2018-0036866 filed on Mar. 29, 2018 in the Korean Intellectual Property Office, the disclosures of which are incorporated herein by reference for all purposes.

### BACKGROUND

### 1. Field

One or more example embodiments relate to a sensor information processing method and system between virtual world and real world, specially, define format of sensor information between devices for real world and virtual world, and provide and convert the sensor information.

### 2. Description of Related Art

Various Sensors existed in real world is used to control element of virtual world, such as object. There are sensors in the real world, so defining the sensor information applied to virtual world is needed. Also, a method for applying the sensor information into the virtual world effectively by understand capabilities of sensor devices for obtaining the sensor information.

### SUMMARY

An aspect provides a method and device that, a converting procedure of sensor information between a real world and a virtual world is effectively performed by defining various sensor information obtained from a camera sensor, and a microphone sensor in the real.

Another aspect also provides a method and device that a converting procedure of sensor information between a real world and a virtual world is effectively performed by defining capability of a camera sensor, and a microphone sensor.

According to an aspect, there is provided a method for processing sensor information between a real world and a virtual world, the method including acquiring first sensing information from a sensor of the real world; converting the first sensing information into virtual world object characteristics applied to the virtual world or second sensing information applied to the virtual world; and applying the virtual world object characteristics or the second sensor information into the virtual world.

The sensor of the real world corresponds to sensor capability description.

A global coordinate depends on environment of the real world is set to the sensor of the real world.

The sensor of the real world includes a camera sensor, and the camera sensor is defined by camera sensor capability type.

The camera sensor capability type includes at least one of SupportedResolutionsFlag, SupportedResolutions, ResolutionListType, Width, Height, FocalLengthRangeFlag, FocalLengthRange, ValueRangeType, ApertureRangeFlag, ApertureRange, ShutterSpeedRangeFlag, ShutterSpeedRange, ISOSpeedRangeFlag, ISOSpeedRange, ExposureValueRangeFlag, ExposureValueRange, VideoFlag, SensorType, ColorFilterArrayFlag, ColorFilterArrayType, ColorSpaceFlag, ColorSpaceType, BitDepthRangeFlag, BitDepthRange, SpectrumRangeFlag, SpectrumRange, ThermalRangeFlag, ThermalRange, WhiteBalanceTempRangeFlag, WhiteBalanceTempRange, WhiteBalanceTintFlag, and WhiteBalanceTintRange.

The sensor of the real world includes a microphone sensor, and the microphone sensor is defined by microphone sensor capability type.

The microphone sensor capability type includes at least one of microphoneType, transducerArrayType, probeType, polarPattern, frequencyRange, responseTypeFlag, responseFrequency, minFreqeuncy, maxFrequency, and pickSensitivity.

The camera sensor is specified based on CameraSensorType, and the CameraSensorType includes at least one of CameraLocation, CameraAltitude, CameraOrientation, focalLength, aperture, shutterSpeed, filter, CameraOrientationFlag, CameraLocationFlag, CameraAltitudeFlag, focalLengthFlag, apertureFlag, shutterSpeedFlag, and filterFlag.

The microphone sensor is specified based on MicrophoneSensorType, and the MicrophoneSensorType includes at least one of OrientationFlag, AltitudeFlag, LocationFlag, sampleRateFlag, resolutionFlag, Orientation, Altitude, Location, sample_rate_size, sample_rate, byte_order, sign, resolution, Signed, Unsigned, BigEndian, LittleEndian, RawAudioDataSize, and RawAudioData.

According to an aspect, there is provided a non-transitory computer-readable media in an electronic device.

The media records sensor information for a sensor of a real world to be applied to a virtual object of a virtual world.

The sensor of the real world corresponds to a sensor capability description.

A global coordinate depends on environment of the real world is set to the sensor of the real world.

The sensor of the real world includes a camera sensor, and the camera sensor is defined by camera sensor capability type.

The camera sensor capability type includes at least one of SupportedResolutionsFlag, SupportedResolutions, ResolutionListType, Width, Height, FocalLengthRangeFlag, FocalLengthRange, ValueRangeType, ApertureRangeFlag, ApertureRange, ShutterSpeedRangeFlag, ShutterSpeedRange, ISOSpeedRangeFlag, ISOSpeedRange, ExposureValueRangeFlag, ExposureValueRange, VideoFlag, SensorType, ColorFilterArrayFlag, ColorFilterArrayType, ColorSpaceFlag, ColorSpaceType, BitDepthRangeFlag, BitDepthRange, SpectrumRangeFlag, SpectrumRange, ThermalRangeFlag, ThermalRange, WhiteBalanceTempRangeFlag, WhiteBalanceTempRange, WhiteBalanceTintFlag, and WhiteBalanceTintRange.

The sensor of the real world includes a microphone sensor, and the microphone sensor is defined by microphone sensor capability type.

The microphone sensor capability type includes at least one of microphoneType, transducerArrayType, probeType, polarPattern, frequencyRange, responseTypeFlag, responseFrequency, minFreqeuncy, maxFrequency, and pickSensitivity.

The camera sensor is specified based on CameraSensorType, and the CameraSensorType includes at least one of CameraLocation, CameraAltitude, CameraOrientation, focalLength, aperture, shutterSpeed, filter, CameraOrientationFlag, CameraLocationFlag, CameraAltitudeFlag, focalLengthFlag, apertureFlag, shutterSpeedFlag, and filterFlag.

The microphone sensor is specified based on MicrophoneSensorType, and the MicrophoneSensorType includes at least one of OrientationFlag, AltitudeFlag, LocationFlag, sampleRateFlag, resolutionFlag, Orientation, Altitude, Location, sample_rate_size, sample_rate, byte_order, sign, resolution, Signed, Unsigned, BigEndian, LittleEndian, RawAudioDataSize, and RawAudioData.

According to an aspect, there is provided a sensor information processing system comprising a media processor.

The media processor is configured to acquire first sensing information from a sensor of the real world, convert the first sensing information into virtual world object characteristics applied to the virtual world or second sensing information applied to the virtual world; and apply the virtual world object characteristics or the second sensor information into the virtual world.

The sensor of the real world corresponds to sensor capability description.

A global coordinate depends on environment of the real world is set to the sensor of the real world.

The sensor of the real world includes a camera sensor, and the camera sensor is defined by camera sensor capability type.

The sensor of the real world includes a microphone sensor, and the microphone sensor is defined by microphone sensor capability type.

The camera sensor is specified based on CameraSensorType.

The microphone sensor is specified based on MicrophoneSensorType.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating system for processing sensor information between virtual world and real world according to an example embodiment;

FIG. 2 is a diagram illustrating a media processor for applying the sensor information obtained from a camera sensor and a microphone sensor in a real world, into virtual world according to an example embodiment;

FIG. 3 is a diagram illustrating a flow chart for converting sensor information between real world and virtual world according to an example embodiment.

### DETAILED DESCRIPTION

The following detailed description is provided to assist the reader in gaining a comprehensive understanding of the methods, devices, and/or systems described herein. However, various changes, modifications, and equivalents of the methods, devices, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms and are not to be construed as being limited to the examples described herein. Rather, the examples described herein have been provided merely to illustrate some of the many possible ways of implementing the methods, devices, and/or systems described herein that will be apparent after an understanding of the disclosure of this application.

Terms such as first, second, A, B, (a), (b), and the like may be used herein to describe components. Each of these terminologies is not used to define an essence, order, or sequence of a corresponding component but used merely to distinguish the corresponding component from other component(s). For example, a first component may be referred to as a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, operations, elements, and/or components, but do not preclude the presence or addition of one or more other features, integers, operations, elements, components, and/or groups thereof.

Unless otherwise defined, all terms, including technical and scientific terms, used herein have the same meaning as commonly understood by one of ordinary skill in the art to which this disclosure pertains based on an understanding of the present disclosure. Terms, such as those defined in commonly used dictionaries, are to be interpreted as having a meaning that is consistent with their meaning in the context of the relevant art and the present disclosure and are not to be interpreted in an idealized or overly formal sense unless expressly so defined herein.

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings.

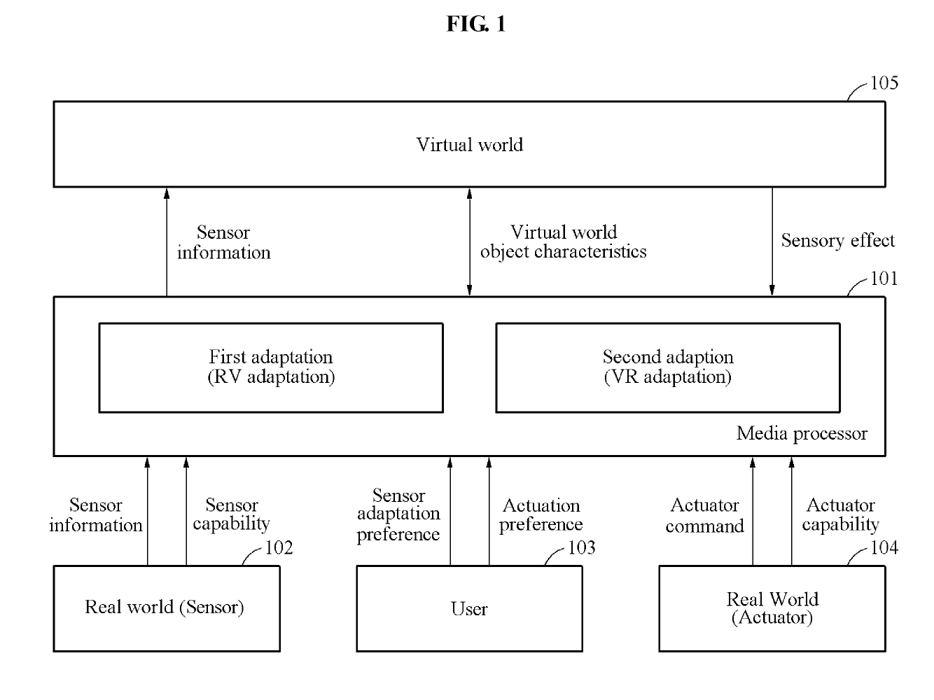

FIG. 1 is a diagram illustrating system for processing sensor information between virtual world and real world according to an example embodiment.

There is an architecture and specifies associated information representations to enable interoperability between virtual worlds, e.g. digital content provider of a virtual world, gaming (serious), simulation, DVD, and the real world, e.g. sensors, actuators, vision and rendering, robotics (e.g. for revalidation), (support for) independent living, social and welfare systems, banking, insurance, travel, real estate, rights management and many others.

Virtual worlds are defined for integrating existing and emerging media technologies (e.g. instant messaging, video, 3D, VR, AI, chat, voice, etc.) that allow for the support of existing and the development of new kinds of social networks.

Media Processor supports control information and sensor information which consists of sensory effect metadata, sensory device capabilities/commands, user sensory preferences, and various delivery formats.

The media processor of the system may process the control information such as capabilities and preferences for sensors and actuators. The control information includes device capability description, and user preference information.

The media processor of the system may exchange information for interaction devices. The media processor may support command formats for controlling actuators and data formats for receiving information from sensors.

According to an example embodiment, the media processor covers the data formats for communicating between the adaptation engine and the capability/preference descriptions of actuators/sensors in FIG. 1. The control information includes the user's actuation preference information, the user's sensor preference information, actuator capability description, and sensor capability description can be used for fine tunings of the sensor information and the actuator command for the control of virtual world/real worlds by providing extra information to the adaptation engine.

According to an example embodiment, a syntax or a symantics is provided to support interoperability in controlling devices (actuators and sensors) in real as well as virtual worlds.

According to an example embodiment, the Control Information Description Language (CIDL) as an XML Schema-based language which enables one to describe a basic structure of control information is specified. The Device Capability Description Vocabulary (DCDV) specifies XML representation for describing capabilities of actuators such as lamps, fans, vibrators, motion chairs, scent generators, etc. For instance, the maximum wind speed (30 m/s), the number of wind levels (5 levels) of a fan can be defined with a description of DCDV.

The Sensor Capability Description Vocabulary (SCDV) specifies interfaces for describing capabilities of sensors such as a light sensor, a temperature sensor, a velocity sensor, a global position sensor, an intelligent camera sensor, etc. For instance, capabilities of a global position sensor (e.g., the maximum operating temperature of 90 degrees Celsius, minimum operating temperature of −30 degrees Celsius, sensitivity of 0.01 degrees, and the position accuracy of 0.01 degree) can be defined with a description of SCDV.

The Sensory Effect Preference Vocabulary (SEPV) specifies interfaces for describing preferences of individual user on specific sensorial effects such as light, wind, scent, vibration, etc. For instance, the maximum intensity of a vibration chair can be defined as 600 Hz with a description of SEPV. The Sensor Adaptation Preference Vocabulary (SAPV) specifies interfaces for describing preferences of sensor of individual user on individual type of sensed information. For instance, a light sensor adaptation can be achieved to detect between the maximum value of 400 (lux) and minimum value of 10 (lux).

According to an example embodiment, the data formats is provided for communicating between the adaptation engine and the actuators/sensors in the real worlds or virtual world objects as being illustrated in FIG. 1.

According to an example embodiment, the syntax and semantics of the data formats for interaction devices is defined by providing a format for interfacing actuators and sensors by defining XML Schema-based language named Interaction Information Description Language (IIDL). IIDL provides a basic structure with common information for communication with various actuators and sensors in consistency. Device Command Vocabulary (DCV) is defined to provide a standardized format for commanding individual actuator, and Sensed Information Vocabulary (SIV) is defined to provide a standardized format for holding information from individual sensors either to get environmental information from real world or to influence virtual world objects using the acquired information on the basis of IIDL.

The adaptation engine, such as RV engine (first adaptation) or VR engine (second adaptation), performs bi-directional communications using data formats. The adaptation engine can also utilize user's sensory preferences (USP), sensory device capabilities (SDC), sensor capabilities (SC), and sensor adaptation preferences (SAP) for fine controlling devices in both real and virtual worlds.

Referring to FIG. 1, the media processor may convert the sensor information between a real world and a virtual world. Media processor can be represented as engine. Media processor may convert sensor information obtained from the real world into sensor information to be applied to the virtual world. Also, media processor may perform first adaptation for converting the sensor information obtained from the real world into virtual world object characteristic of the virtual world. And, media processor may perform second adaptation for converting sensor effect data of the virtual world or virtual world object characteristics into a actuator command to be applied in the real world. Here, adaption is defined as engine in the media processor.

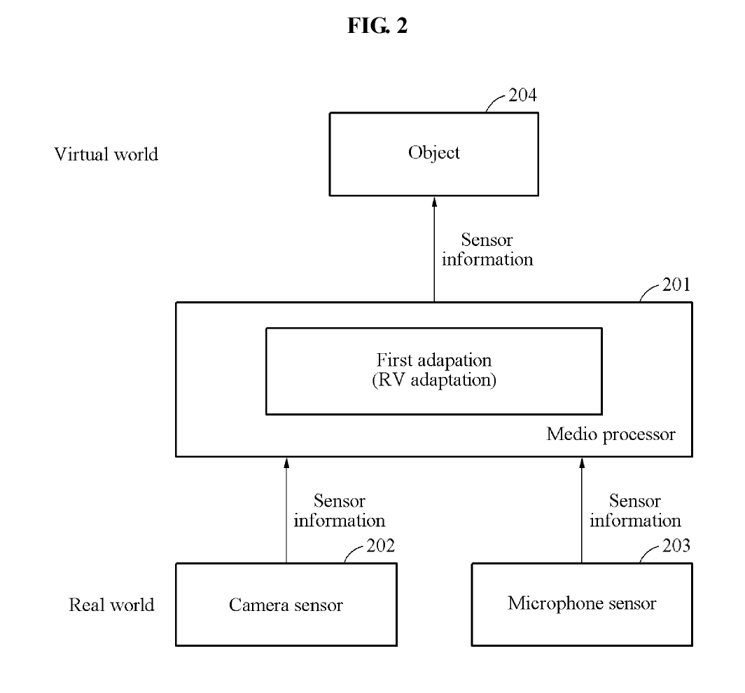

FIG. 2 is a diagram illustrating a media processor for applying the sensor information obtained from a camera sensor and a microphone sensor in a real world, into virtual world according to an example embodiment.

The FIG. 2 shows collecting procedure for the sensor information from camera sensor 202 and microphone sensor of a real world. The camera sensor 202 may provide the obtained sensor information to the media processor 201. Also, the microphone sensor 203 may provide the acquired sensor information to the media processor 201. The sensor information obtained from the camera sensor 202, and the microphone sensor 203 can be processed by a first adaptation which performed in the media processor 201. Here, the first adaption is represented as engine.

The media processor 201 may convert the sensor information collected from camera sensor 202 and microphone sensor 203 using the first adaption and apply the converted sensor information into the object 204 of the virtual world.

The format is provided for the sensor information to be collected from the camera sensor 202, and the microphone sensor 203 or to be processed in the media processor. Also, the format is provided for the sensor capability of the camera sensor 202 and microphone sensor 203.

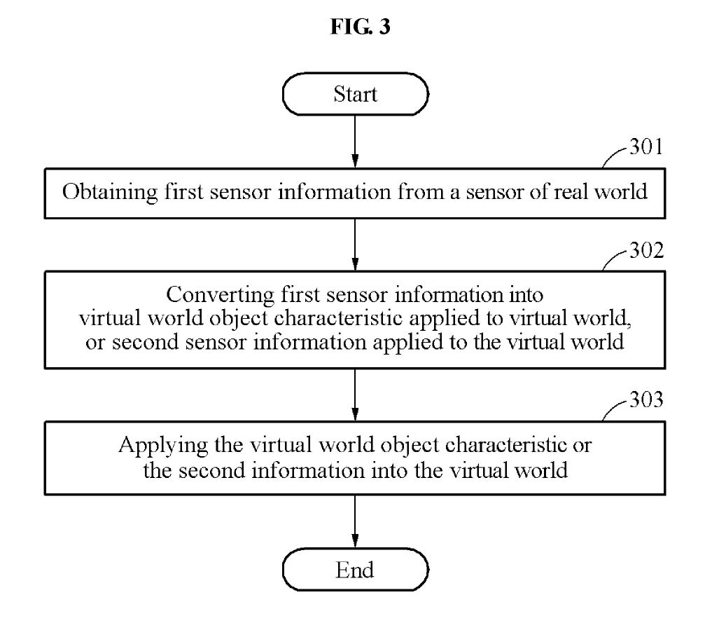

FIG. 3 is a diagram illustrating a flow chart for converting sensor information between real world and virtual world according to an example embodiment;

In step 301, the media processor may acquire the first information from the sensor of real world. The sensor of real world includes the camera sensor for image, and the microphone sensor for audio.

In step 302, the media processor may convert the first sensor information into the second sensor information to be applied into the virtual world object characteristics, or virtual world.

In step 303, the media processor may apply the virtual world object characteristics or the second sensor information into the virtual world.

In the following, the data formats and detailed description is explained in the first embodiment, and the second embodiment.

### The First Embodiment

1. Additional Metadata for Media Orchestration

Depending on the application, sensor characteristics, or sensor capabilities, the characteristics of captures image(video) are different. In order for a media processorsuccessfully process acquired data, i.e., group, merge, separate, etc., more detailed metadata on captured image's base characteristics are necessary.

The rich information for media processor in terms of basic characteristics of the captured image(video) is provided.

The below table 1 is syntax for imageCharacteristics, and table 2 is syntax for imageCharacteristicsAttributes.

TABLE 1

| | |
|---|---|
| Number of bits | Mnemonic |

imageCharacteristics {

| | | |
|---|---|---|
| imageStreamFlag | 1 | bslbf |
| imageCharacteristics | | imageCharacteristicsAttributes |
| if (imageStreamFlag == 1){ | | |

| | | |
|---|---|---|
| charUpdateFlag | 1 | fsbf |
| if (charUpdateFlag == 1){ | | |
| imageCharacteristics | | imageCharacteristicsAttributes |
| } | | |

}

TABLE 2

| | |
|---|---|
| Number of bits | Mnemonic |

imageCharacteristicsAttributes {

| | | |
|---|---|---|
| colorImageFlag | 1 | bslbf |
| filterFlag | 1 | bslbf |
| colorSpaceFlag | 1 | bslbf |
| bitDepthFlag | 1 | bslbf |
| waveLengthFlag | 1 | bslbf |
| temperatureFlag | 1 | bslbf |
| tintFlag | 1 | bslbf |
| if (filterFlag == 1){ | | |

| | | |
|---|---|---|
| filter | 4 | bslbf |

}
if (colorSpaceFlag == 1){

| | | |
|---|---|---|
| colorSpaceIDLength | | vluimsbf |
| colorSpaceID | colorSpaceIDLength*8 | UTF-8 |

}
if (bitDepthFlag == 1){

| | | |
|---|---|---|
| bitDepth | 8 | fsbf |

}
if (waveLengthFlag == 1){

| | | |
|---|---|---|
| minWaveLength | 14 | fsbf |
| maxWaveLength | 14 | fsbf |

}
if (temperatureFlag == 1){

| | | |
|---|---|---|
| temperature | 14 | fsbf |

}
if (tintFlag == 1){

| | | |
|---|---|---|
| tint | 16 | simsbf |

}

The table 3 denotes semantics for image obtained from an image sensor.

TABLE 3

| Name | Definition |
|---|---|
| imageStreamFlag | ‘1’ if video or image streaming |
| imageCharacteristics | Defines characteristics of captured image(s) |
| charUpdateFlag | ‘1’ if any characteristic of currently captured image is different |
| | from the previous one |
| colorImageFlag | ‘0’ if color, ‘1’ if grayscale |
| filterFlag | ‘1’ if any filter is applied |
| colorSpaceFlag | ‘1’ if colorSpace is defined |
| bitDepthFlag | ‘1’ if bitDepth is defined |
| waveLengthFlag | ‘1’ if waveLength range of captured image is defined |
| temperatureFlag | ‘1’ if white balance temperature is defined |
| tint | ‘1’ if white balance tint is defined |
| colorSpaceIDLength | Length of colorSpaceID |
| colorSpaceID | Identifies color space used in image capturing |
| bitDepth | Current bit depth setting |
| waveLength | Current wavelength setting in nanometer |
| temperature | Current white balance temperature setting in Kelvin |
| tint | Current white balance tint setting |

For special types of surveillance system such as fire detection, night watch, etc, the characteristics of captured images are different. For example, thermal IR images used in fire detection or body heat detection in the airport may have different characteristics. Therefore, by providing rich image metadata, media processor may be able to group, merge, or classify images(video) from different sources or in the sink accurately.

The below table 4 is syntax for Camera Sensor Type, and table 5 is binary representation for Camera Sensor Type.

TABLE 4

| <!-- ################################################ --> | |
|---|---|
| <!-- Camera Sensor Type | --> |

| <!-- ################################################ --> | | |
|---|---|---|
| <complexType name=“CameraSensorType”> | | |
| <complexContent> | | |
| <extension base=“iidl:SensedInfoBaseType”> | | |
| <sequence> | | |
| <element | name=“CameraGlobalPosition” | type=“siv:GlobalPositionSensorType” |

minOccurs=“0”/>

| | | |
|---|---|---|
| <element | name=“CameraOrientation” | type=“siv:OrientationSensorType” |

minOccurs=“0”/>

| <element name=“CameraAltitude” type=“siv:AltitudeSensorType” minOccurs=“0”/> | | |
|---|---|---|
| <element | name=“CameraLocalPosition” | type=“siv:PositionSensorType” |

minOccurs=“0”/>

<attribute name=“focalLength” type=“float” use=“optional”/>
<attribute name=“aperture” type=“float” use=“optional”/>
<attribute name=“shutterSpeed” type=“float” use=“optional”/>
<attribute name=“filter” type=“mpeg7:termReferenceType” use=“optional”/>
<attribute name=“ISOSpeed” type=“float” use=“optional”/>
<attribute name=“ExposureValue” type=“float” use=“optional”/>
<attribute name=“ColorFilter” type=“siv:ColorFilterArrayListType” use=“optional”/>
<attribute name=“Video” type=“boolean” use=“optional”/>
<attribute name=“SensorType” type=“boolean” use=“optional”/>
<attribute name=“ColorSpaceType” type=“string” use=“optional”/>
<attribute name=“BitDepth” type=“unsigned8” use=“optional”/>
<attribute name=“SpectrumRange” type=“siv:ValueRangeType” use=“optional”/>
<attribute name=“ThermalRange” type=“ siv:ValueRangeType” use=“optional”/>
<attribute name=“WhiteBalanceTemp” type=“float” use=“optional”/>
<attribute name=“WhiteBalanceTint” type=“signed8” use=“optional”/>
</sequence>
</extension>
</complexContent>
</complexType>
<complexType name=“ValueRangeType”>
<sequence>
<element name=“MaxValue” type=“float”/>
<element name=“MinValue” type=“float”/>
</sequence>
</complexType>
<simpleTypename=“ColorFilterArrayListType”>
<restriction base=“string”>
<enumeration value=“Bayer”/>
<enumeration value=“RGBE”/>
<enumeration value=“CYYM”/>
<enumeration value=“CYGM”/>
<enumeration value=“RGB Bayer”/>
<enumeration value=“RGBW #1”/>
<enumeration value=“RGBW #2”/>
<enumeration value=“RGBW #3”/>
</restriction>
</simpleType>

TABLE 5

| | Number of bits | Mnemonic |
|---|---|---|
| CameraSensorType { | | |
| CameraGlobalPositionFlag | 1 | bslbf |
| CameraLocalPositionFlag | 1 | bslbf |
| SupportedResolutionsFlag | 1 | bslbf |
| FocalLengthFlag | 1 | bslbf |
| ApertureFlag | 1 | bslbf |
| ShutterSpeedFlag | 1 | bslbf |
| FilterFlag | 1 | bslbf |
| ISOSpeedFlag | 1 | bslbf |
| Exposure ValueFlag | 1 | bslbf |
| ColorFilterArrayFlag | 1 | bslbf |
| VideoFlag | 1 | bslbf |
| SensorType | 1 | bslbf |
| ColorSpaceFlag | 1 | bslbf |
| BitDepthFlag | 1 | bslbf |
| SpectrumRangeFlag | 1 | bslbf |
| ThermalRangeFlag | 1 | bslbf |
| WhiteBalanceTempFlag | 1 | bslbf |
| WhiteBalanceTintFlag | 1 | bslbf |
| SensedInfoBaseType | | SensedlnfoBaseType |
| if (CameraGlobalPositionFlag == 1){ | | |
| CameraGlobalPosition | | GlobalPositionSensorType |
| Camera Altitude | | AltitudeSensorType |
| CameraOrientation | | OrientationSensorType |
| } | | |
| if (CameraLocalPositionFlag == 1){ | | |
| CameraLocalPositionFlag | | PositionSensorType |
| CameraOrientation | | OrientationSensorType |
| } | | |
| if(SupportedResolutionsFlag) { | | |
| SupportedResolutions | | ResolutionListType |
| } | | |
| if(FocalLengthFlag) { | | |
| FocalLength | 32 | fsbf |
| } | | |
| if(ApertureFlag) { | | |
| Aperture | 32 | fsbf |
| } | | |
| if(ShutterSpeedFlag) { | | |
| ShutterSpeed | 32 | fsbf |
| } | | |
| if(FilterFlag) { | | |
| Filter | 4 | bslbf |
| } | | |
| if(ISOFlag) { | | |
| ISOSpeed | 32 | fsbf |
| } | | |
| if(ExposureValueFlag) { | | |
| ExposureValue | 32 | fsbf |
| } | | |
| if(ColorFilterArrayFlag) { | | |
| ColorFilterArrayType | | ColorFilterArrayListType |
| } | | |
| if(ColorSpaceFlag) { | | |
| ColorSpaceTypeLength | | vluimsbf |
| ColorSpaceType | ColorSpaceTypeLength*8 | UTF-8 |
| } | | |
| if(BitDepthFlag) { | | |
| BitDepth | 8 | ValueRangeType |
| } | | |
| if(SpectrumRangeFlag) { | | |
| SpectrumRange | 32 | ValueRangeType |
| } | | |
| if(ThermalRangeFlag) { | | |
| ThermalRange | | ValueRangeType |
| } | | |
| if(WhiteBalanceTempFlag) { | | |
| WhiteBalanceTemp | 32 | ValueRangeType |
| } | | |
| if(WhiteBalanceTintFlag) { | | |
| WhiteBalanceTint | 8 | simsbf |
| } | | |
| } | | |
| ResolutionListType { | | |
| LoopResolution | | vluimsbf |
| for(k=0;k< LoopResolution;k++) { | | |
| Resolution[k] | | ResolutionType |
| } | | |
| } | | |
| ResolutionType { | | |
| Width | 32 | uimsbf |
| Height | 32 | uimsbf |
| } | | |
| ValueRangeType { | | |
| MaxValue | 32 | fsbf |
| MinValue | 32 | fsbf |
| } | | |

The table 6 denotes semantics for CameraSensorCapabilityType.

TABLE 6

| Name | Definition |
|---|---|
| CameraSensorType | Tool for describing sensed information with respect to a |
| | camera sensor. |
| CameraGlobalPosition | Defines global positioning sensor based position information of |
| | Camera |
| CameraAltitude | Defines altitude of Camera |
| CameraOrientation | Defines orientation of Camera |
| CameraLocalPosition | Defines relative location of Camera |
| SupportedResolutionsFlag | This field, which is only present in the binary representation, |
| | signals the presence of the SupportedResolutions element. A |
| | value of “1” means that this element is present and “0” means |
| | that this element is not present. |
| SupportedResolutions | Describes a list of resolution that the camera can support. |
| ResolutionListType | Describes a type of the resolution list which is composed of |
| | ResolutionType element. |
| ResolutionType | Describes a type of resolution which is composed of Width |
| | element and Height element. |
| Width | Describes a width of resolution that the camera can perceive. |
| Height | Describes a height of resolution that the camera can perceive. |
| FocalLengthFlag | This field, which is only present in the binary representation, |
| | signals the presence of the FocalLength element. A value of |
| | “1” means that this element is present and “0” means that this |
| | element is not present. |
| FocalLength | Describes the distance between the lens and the image sensor |
| | when the subject is in focus, in terms of millimeters (mm). |
| ValueRangeType | Defines the range of the value that the sensor can perceive. |
| MaxValue | Describes the maximum value that the sensor can perceive. |
| MinValue | Describes the minimum value that the sensor can perceive. |
| ApertureFlag | This field, which is only present in the binary representation, |
| | signals the presence of the Aperture element. A value of “1” |
| | means that this element is present and “0” means that this |
| | element is not present. |
| Aperture | Describes the aperture of a camera It is expressed as F-stop, |
| | e.g. F2.8. It may also be expressed as f-number notation such |
| | as f/2.8. |
| ShutterSpeedFlag | This field, which is only present in the binary representation, |
| | signals the presence of the ShutterSpeed element. A value of |
| | “1” means that this element is present and “0” means that this |
| | element is not present. |
| ShutterSpeed | Describes the time that the shutter remains open when taking a |
| | photograph in terms of seconds (sec). |
| filterFlag | This field, which is only present in the binary representation, |
| | signals the presence of filter attribute. A value of “1” means the |
| | attribute shall be used and “0” means the attribute shall not be |
| | used. |
| filter | Describes kinds of camera filters as a reference to a |
| | classification scheme term that shall be using the mpeg7. The |
| | CS that may be used for this purpose is the |
| | CameraFilterTypeCS. |
| ISOSpeedFlag | This field, which is only present in the binary representation, |
| | signals the presence of the ISOSpeed element. A value of “1” |
| | means that this element is present and “0” means that this |
| | element is not present. |
| ISOSpeed | Describes the ISO speed based on ISO. |
| ExposureValueFlag | This field, which is only present in the binary representation, |
| | signals the presence of the ExposureValue element. A value |
| | of “1” means that this element is present and “0” means that |
| | this element is not present. |
| ExposureValue | Describes the exposure value. |
| VideoFlag | Describes image shooting mode. “0” for still image and “1” for |
| | video. |
| SensorType | Describes type of sensor used. “0” for monochrome sensor, “1” |
| | for color sensor. |
| ColorFilterArrayFlag | This field, which is only present in the binary representation, |
| | signals the presence of the ColorFilterArrayType element. A |
| | value of “1” means that this element is present and “0” means |
| | that this element is not present. |
| ColorFilterArray | Describes the color filter array applied to the image sensor of a |
| | camera |
| | 0000 Reserved |
| | 0001 Bayer |
| | 0010 RGBE |
| | 0011 CYYM |
| | 0100 CYGM |
| | 0101 RGBW Bayer |
| | 0110 RGBW #1 |
| | 0111 RGBW #2 |
| | 1000 RGBW #3 |
| | 1001-1111 Reserved |
| ColorSpaceFlag | This field, which is only present in the binary representation, |
| | signals the presence of the ColorSpaceType element. A value |
| | of “1” means that this element is present and “0” means that |
| | this element is not present. |
| ColorSpaceType | Describes the color space applied. |
| BitDepthFlag | This field, which is only present in the binary representation, |
| | signals the presence of the BitDepth element. A value of “1” |
| | means that this element is present and “0” means that this |
| | element is not present. |
| BitDepth | Describes applied bit depth |
| SpectrumRangeFlag | This field, which is only present in the binary representation, |
| | signals the presence of the SpectrumRange element. A value |
| | of “1” means that this element is present and “0” means that |
| | this element is not present. |
| SpectrumRange | Describes applied spectrum range that the camera sensor |
| | perceived in terms of valueRangeType. Its default unit is |
| | nanometer (nm). |
| | NOTE The minValue and the maxValue in the |
| | SensorCapabilityBaseType are not used for this sensor. |
| ThermalRangeFlag | This field, which is only present in the binary representation, |
| | signals the presence of the ThermalRange element. A value |
| | of “1” means that this element is present and “0” means that |
| | this element is not present. |
| ThermalRange | Describes applied thermal response range that the camera |
| | sensor perceived in terms of valueRangeType. Its default unit |
| | is Celsius (° C.). |
| | NOTE The minValue and the maxValue in the |
| | SensorCapabilityBaseType are not used for this sensor. |
| WhiteBalanceTempFlag | This field, which is only present in the binary representation, |
| | signals the presence of the WhiteBalanceTemp element. A |
| | value of “1” means that this element is present and “0” means |
| | that this element is not present. |
| WhiteBalanceTemp | Describes applied white balance temperature in Kelvin (K). |
| WhiteBalanceTintFlag | This field, which is only present in the binary representation, |
| | signals the presence of the WhiteBalanceTint element. A |
| | value of “1” means that this element is present and “0” means |
| | that this element is not present. |
| WhiteBalanceTint | Describes applied white balance tint value. |

For special types of surveillance system such as fire detection, night watch, etc, the characteristics of captured images are different. For example, thermal IR images used in fire detection or body heat detection in the airport may have different characteristics. Therefore, by providing rich image metadata, media processor may be able to group, merge, or classify images(video) from different sources or in the sink accurately.

<Response to IoMT&W CfP>

In response to IoMT&W Cft, this document proposes metadata necessary to describe data obtained by MThings. The syntax and semantics are given in binary format, however, depending on the IoMT&W system and application, they can be converted and used in XML format.

(a) Physical Characteristics Metadata

There are countless elements to describe physical characteristics of IoMT&W device/entity. This document focuses on position metadata of a IoMT&W device/entity.

(i) Geographical Location

Geographical location metadata is inclusive of longitude, latitude, altitude, and orientation of acquisition focal point. The data may be preset by an operator or can be obtained using proper sensor(s).

The below table 6 shows syntax for GeographicalPositioning. And, table 7 is syntax related to GeoPositionAttributes.

TABLE 6

| | | |
|---|---|---|
| Syntax | Number of bits | Mnemonic |

GeographicalPositioning {

| | | |
|---|---|---|
| GeoPosition | | GeoPositionAttributes |
| StationaryFlag | 1 | bslbf |
| if (StationaryFlag == 1){ | | |

| | |
|---|---|
| GeoPosition | GeoPositionAttributes |
| } | |

}

TABLE 7

| | | |
|---|---|---|
| Syntax | Number of bits | Mnemonic |

GeoPositionAttributes {

| | | |
|---|---|---|
| Longitude | 32 | fsfb |
| Latitude | 32 | fsfb |
| Altitude | 32 | fsfb |
| AltUnitType | 1 | bslbf |
| Yaw | 32 | Fsfb |
| Pitch | 32 | fsfb |
| Roll | 32 | fsfb |
| YPRUnitType | 1 | bslbf |

}

}

(ii) Relative Location

Different Geographical location, which is an absolute data, position of an IoMT&W may be provided relatively to a predefined point of origin.

The table 8 is syntax related to LocalPositioning, and table 9 is syntax is related to LocalPositionAttributes.

TABLE 8

| | | |
|---|---|---|
| Syntax | Number of bits | Mnemonic |

LocalPositioning {

| | | |
|---|---|---|
| LocalPosition | | LocalPositionAttributes |
| StationaryFlag | 1 | bslbf |
| if (StationaryFlag == 1){ | | |

| | |
|---|---|
| LocalPosition | LocalPositionAttributes |
| } | |

}

TABLE 9

| | | |
|---|---|---|
| Syntax | Number of bits | Mnemonic |

LocalPositionAttributes {

| | | |
|---|---|---|
| X | 32 | fsfb |
| Y | 32 | fsfb |
| Z | 32 | fsfb |
| XYZUnitType | 1 | bslbf |
| Yaw | 32 | fsfb |
| Pitch | 32 | fsfb |
| Roll | 32 | fsfb |
| YPRUnitType | 1 | bslbf |

}

}

(b) Data Acquisition (Sensor) Characteristics Metadata

Different Geographical location, which is an absolute data, position of an IoMT&W may be provided relatively to a predefined point of origin.

(i) Image (Video)

Image (Video) acquisition metadata can be classified in two; one is camera setting metadata and the other is acquired image's characteristic metadata.

* Camera Settings

The table 9 is syntax related to Camera Setting.

TABLE 9

| | | |
|---|---|---|
| Syntax | Number of bits | Mnemonic |

CameraSetting {

| | | |
|---|---|---|
| focalLengthFlag | 1 | bslbf |
| apertureFlag | 1 | bslbf |
| shutterSpeedFlag | 1 | bslbf |
| filterFlag | 1 | bslbf |
| if (focalLengthFlag == 1){ | | |

| | | |
|---|---|---|
| focalLength | 32 | fsbf |

}
if (apertureFlag == 1){

| | | |
|---|---|---|
| aperture | 32 | fsbf |

}
if (shutterSpeedFlag == 1){

| | | |
|---|---|---|
| shutterSpeed | 32 | fsbf |

}
if (filterFlag == 1){

| | | |
|---|---|---|
| filter | 4 | bslbf |

}

}

The table 10 shows symantics for camera.

TABLE 10

| Name | Definition |
|---|---|
| focalLength | Focal Length at the time of acquisition |
| aperture | Aperture setting |
| shutterSpeed | Shutter speed setting |
| filter | Applied filter |

* Image Characteristics

The table 11 shows syntax for imageCharacteristicsData, and table 12 shows syntax for imageCharacteristicsAttributes.

TABLE 11

| | | |
|---|---|---|
| Syntax | Number of bits | Mnemonic |

imageCharacteristicsData {

| | | |
|---|---|---|
| imageStreamFlag | 1 | bslbf |
| imageCharacteristics | | imageCharacteristicsAttributes |
| if (imageStreamFlag == 1){ | | |

| | | |
|---|---|---|
| charUpdateFlag | 1 | bslbf |
| if (charUpdateFlag == 1){ | | |
| imageCharacteristics | | imageCharacteristicsAttributes |
| } | | |

}

TABLE 12

| | | |
|---|---|---|
| Syntax | Number of bits | Mnemonic |

imageCharacteristicsAttributes {

| | | |
|---|---|---|
| colorImageFlag | 1 | bslbf |
| filterFlag | 1 | bslbf |
| colorSpaceFlag | 1 | bslbf |
| bitDepthFlag | 1 | bslbf |
| waveLengthFlag | 1 | bslbf |
| temperatureFlag | 1 | bslbf |
| tintFlag | 1 | bslbf |
| if (filterFlag == 1){ | | |

| | | |
|---|---|---|
| filter | 4 | bslbf |

}
if (colorSpaceFlag == 1){

| | | |
|---|---|---|
| colorSpaceIDLength | | vluimsbf |
| colorSpaceID | colorSpaceIDLength*8 | UTF-8 |

}
if (bitDepthFlag == 1){

| | | |
|---|---|---|
| bitDepth | 8 | fsbf |

}
if (waveLengthFlag == 1){

| | | |
|---|---|---|
| minWaveLength | 14 | fsbf |
| maxWaveLength | 14 | fsbf |

}
if (temperatureFlag == 1){

| | | |
|---|---|---|
| temperature | 14 | fsbf |

}
if (tintFlag == 1){

| | | |
|---|---|---|
| tint | 16 | simsbf |

}

The table 13 shows symantics for image characteristics.

TABLE 13

| Name | Definition |
|---|---|
| imageStreamFlag | ‘1’ if video or image streaming |
| imageCharacteristics | Defines characteristics of captured image(s) |
| charUpdateFlag | ‘1’ if any characteristic of currently captured image is different |
| | from the previous one |
| colorImageFlag | ‘0’ if color, ‘1’ if grayscale |
| filterFlag | ‘1’ if any filter is applied |
| colorSpaceFlag | ‘1’ if colorSpace is defined |
| bitDepthFlag | ‘1’ if bitDepth is defined |
| waveLengthFlag | ‘1’ if waveLength range of captured image is defined |
| temperatureFlag | ‘1’ if white balance temperature is defined |
| tintFlag | ‘1’ if white balance tint is defined |
| colorSpaceIDLength | Length of colorSpaceID |
| colorSpaceID | Identifies color space used in image capturing |
| bitDepth | Current bit depth setting |
| waveLength | Current wavelength setting in nanometer |
| minWaveLength | Minimum wavelength in nanometer |
| maxWaveLength | Maximum wavelength in nanometer |
| temperature | Current white balance temperature setting in Kelvin |
| tint | Current white balance tint setting |

* Sound

Followings provide sound transducer characteristics (microphone) for sound wave acquisition. The table 14 shows syntax for soundTransducerAttributes.

TABLE 14

| Syntax | | Number of bits | Mnemonic |
|---|---|---|---|
| | soundTransducerAttributes { | | |
| | transducerTypeFlag | 1 | bslbf |
| | transducerArrayFlag | 1 | bslbf |
| | probeTypeFlag | 1 | bslbf |
| | polarPatternTypeFlag | 1 | bslbf |
| | frequencyRangeFlag | 1 | bslbf |
| | frequencyResponseFlag | 1 | bslbf |
| | sensitivityFlag | 1 | bslbf |
| | } | | |
| | if (transducerTypeFlag == 1){ | | |
| | transducerType | 4 | fsbf |
| | } | | |
| | if (transducerArrayFlag == 1){ | | |
| | transducer Array | 4 | fsbf |
| | } | | |
| | if (probeTypeFlag == 1){ | | |
| | probeType | 4 | fsbf |
| | } | | |
| | if (polarPatternTypeFlag == 1){ | | |
| | polarPattern | 4 | fsbf |
| | } | | |
| | if (frequencyRangeFlag == 1){ | | |
| | minFrequency | 24 | fsbf |
| | maxFrequency | 24 | fsbf |
| | } | | |
| | if (frequencyResponseFlag == | | |

1){

| | | |
|---|---|---|
| minResponseFrequency | 24 | fsbf |
| maxResponseFrequency | 24 | fsbf |
| } | | |
| if (sensitivityFlag == 1){ | | |
| sensitivity | 8 | fsbf |
| } | | |

The table 15 shows symantics for transducerType.

TABLE 15

| Name | Definition |
|---|---|
| transducerType | Defines type of transducer |
| | 0000 Reserved |
| | 0001 Condenser |
| | 0010 Dynamic |
| | 0011 Ribbon |
| | 0100 Carbon |
| | 0101 Piezoelectric |
| | 0110 Fiber Optic |
| | 0111 Laser |
| | 1000 Liquid |
| | 1001 MEMS |
| | 1010-1111 Reserved |
| transducerArray | Defines array types of transducer probes |
| | 0000 Reserved |
| | 0001 single array |
| | 0010 linear array |
| | 0011 curvilinear |
| | 0100 phased |
| | 0101 annular |
| | 0110 matrix array |
| | 0111-1111 Reserved |
| probeType | Defines probing type of transducer |
| | 0000 Reserved |
| | 0001 linear probe |
| | 0010 sector probe |
| | 0011 convex probe |
| | 0100 trapezoid probe |
| | 0101-1111 Reserved |
| polarPattern | Defines polar pattern of transducer |
| | 0000 Reserved |
| | 0001 Omnidirectional |
| | 0010 Bi-directional (or Figure of 8) |
| | 0011 Subcardioid |
| | 0100 Cardioid |
| | 0101 Hypercardioid |
| | 0110 Supercardioid |
| | 0111 Shotgun |
| | 1000-1111 Reserved |
| minFrequency | Minimum pickup frequency in Hz |
| maxFrequency | Maximum pickup frequency in Hz |
| frequencyResponseFlag | ‘0’ if Flat frequency response |
| | ‘1’ if Tailored frequency response |
| minResponseFreqeuncy | Minimum Pick response frequency in Hz |
| maxResponseFrequency | Maximum Pick response frequency in Hz |
| sensitivity | Pick sensitivity of transducer in mV/Pa |

* Camera Capability

Image (Video) acquisition metadata can be classified in two; one is camera setting metadata and the other is acquired image's characteristic metadata.

The table 16 shows syntax for CameraSensorCapabilityType, and table 17 shows syntax for CameraSensorCapabilityType.

TABLE 16

| <complexType name=“CameraSensorCapabilityType”> | | |
|---|---|---|
| <complexContent> | | |
| <extensionbase=“cidl:SensorCapabilityBaseType”> | | |
| <sequence> | | |
| <element | name=“SupportedResolutions” | type=“scdv:ResolutionListType” |

minOccurs=“0”/>

| | | |
|---|---|---|
| <element | name=“FocalLengthRange” | type=“scdv:ValueRangeType” |

minOccurs=“0”/>

| <element name=“ApertureRange” type=“scdv:ValueRangeType” minOccurs=“0”/> | | |
|---|---|---|
| <element | name=“ShutterSpeedRange” | type=“scdv:ValueRangeType” |

minOccurs=“0”/>

| <element name=“ISOSpeedRange” type=“scdv:ValueRangeType” minOccurs=“0”/> | | |
|---|---|---|
| <element | name=“ExposureValueRange” | type=“scdv:ValueRangeType” |

minOccurs=“0”/>

<element name=“ColorFilterArrayType” type=“scdv:ColorFilterArrayListType”

minOccurs=“0”/>

| <element name=“Video” type=“boolean” minOccurs=“0”/> | | |
|---|---|---|
| <element name=“ Sensor Type” type=“boolean” minOccurs=“0”/> | | |
| <element name=“ColorSpaceType” type=“string” minOccurs=“0”/> | | |
| <element name=“BitDepthRange” type=“scdv:ValueRangeType” minOccurs=“0”/> | | |
| <element name=“SpectrumRange” type=“scdv:ValueRangeType” minOccurs=“0”/> | | |
| <element name=“ThermalRange” type=“scdv:ValueRangeType” minOccurs=“0”/> | | |
| <element | name=“WhiteBalanceTempRange” | type=“scdv:ValueRangeType” |

minOccurs=“0”/>

| | | |
|---|---|---|
| <element | name=“WhiteBalanceTintRange” | type=“scdv:ValueRangeType” |

minOccurs=“0”/>

</sequence>
</extension>
</complexContent>
</complexType>
<complexType name=“ResolutionListType”>
<sequence>

| | | |
|---|---|---|
| <element | name=“Resolution” | type=“scdv:ResolutionType” |

maxOccurs=“unbounded”/>

</sequence>
</complexType>
<complexType name=“ResolutionType”>
<sequence>
<element name=“Width” type=“nonNegativeInteger”/>

<element name=“Height” type=“nonNegativeInteger”/>

</sequence>
</complexType>
<complexType name=“ValueRangeType”>
<sequence>
<element name=“MaxValue” type=“float”/>

<element name=“MinValue” type=“float”/>

</sequence>
</complexType>
<simpleType name=“ColorFilterArrayListType”>
<restriction base=“string”>
<enumeration value=“Bayer”/>
<enumeration value=“RGBE”/>
<enumeration value=“CYYM”/>
<enumeration value=“CYGM”/>
<enumeration value=“RGB Bayer”/>
<enumeration value=“RGBW #1”/>
<enumeration value=“RGBW #2”/>
<enumeration value=“RGBW #3”/>
</restriction>
</simpleType>

TABLE 17

| CameraSensorCapabilityType { | Number of bits | Mnemonic |
|---|---|---|
| SupportedResolutionsFlag | 1 | bslbf |
| FocalLengthRangeFlag | 1 | bslbf |
| ApertureRangeFlag | 1 | bslbf |
| ShutterSpeedRangeFlag | 1 | bslbf |
| ISORangeFlag | 1 | bslbf |
| ExposureValueRangeFlag | 1 | bslbf |
| ColorFilterFlag | 1 | bslbf |
| VideoFlag | 1 | bslbf |
| SensorType | 1 | bslbf |
| ColorSpaceFlag | 1 | bslbf |
| BitDepthRangeFlag | 1 | bslbf |
| SpectrumRangeFlag | 1 | bslbf |
| ThermalRangeFlag | 1 | bslbf |
| WhiteBalanceTempRangeFlag | 1 | bslbf |
| WhiteBalanceTintRangeFlag | 1 | bslbf |
| SensorCapabilityBase | | SensorCapabilityBaseType |
| if(SupportedResolutionsFlag) { | | |
| SupportedResolutions | | ResolutionListType |
| } | | |
| if(FocalLengthRangeFlag) { | | |
| FocalLengthRange | | ValueRangeType |
| } | | |
| if(ApertureRangeFlag) { | | |
| ApertureRange | | ValueRangeType |
| } | | |
| if(ShutterSpeedRangeFlag) { | | |
| ShutterSpeedRange | | ValueRangeType |
| } | | |
| if(ISOSpeedRangeFlag) { | | |
| ISOSpeedRange | | ValueRangeType |
| } | | |
| if(ExposureValueRangeFlag) { | | |
| ExposureValueRange | | ValueRangeType |
| } | | |
| if(ColorFilterArrayFlag) { | | |
| ColorFilterArrayType | | ColorFilterArrayListType |
| } | | |
| if(ColorSpaceFlag) { | | |
| ColorSpaceTypeLength | | vluimsbf |
| ColorSpaceType | ColorSpaceTypeLength*8 | UTF-8 |
| } | | |
| if(BitDepthRangeFlag) { | | |
| BitDepthRange | | ValueRangeType |
| } | | |
| if(SpectrumRangeFlag) { | | |
| SpectrumRange | | ValueRangeType |
| } | | |
| if(ThermalRangeFlag) { | | |
| ThermalRange | | ValueRangeType |
| } | | |
| if(WhiteBalanceTempRangeFlag) { | | |
| WhiteBalanceTempRange | | ValueRangeType |
| } | | |
| if(WhiteBalanceTintRangeFlag) { | | |
| WhiteBalanceTintRange | | ValueRangeType |
| } | | |
| } | | |
| ResolutionListType { | | |
| LoopResolution | | vluimsbf |
| for(k=0;k< LoopResolution;k++) { | | |
| Resolution[k] | | ResolutionType |
| } | | |
| } | | |
| ResolutionType { | | |
| Width | 32 | uimsbf |
| Height | 32 | uimsbf |
| } | | |
| ValueRangeType { | | |
| Max Value | 32 | fsbf |
| MinValue | 32 | fsbf |
| } | | |

The table 18 shows symantics for CameraSensorCapabilityType.

TABLE 18

| Name | Definition |
|---|---|
| CameraSensorCapabilityType | Tool for describing a camera sensor capability. |
| SupportedResolutionsFlag | This field, which is only present in the binary representation, |
| | signals the presence of the SupportedResolutions element. A |
| | value of “1” means that this element is present and “0” means |
| | that this element is not present. |
| SupportedResolutions | Describes a list of resolution that the camera can support. |
| ResolutionListType | Describes a type of the resolution list which is composed of |
| | ResolutionType element. |
| ResolutionType | Describes a type of resolution which is composed of Width |
| | element and Height element. |
| Width | Describes a width of resolution that the camera can perceive. |
| Height | Describes a height of resolution that the camera can perceive. |
| FocalLengthRangeFlag | This field, which is only present in the binary representation, |
| | signals the presence of the FocalLengthRange element. A |
| | value of “1” means that this element is present and “0” means |
| | that this element is not present. |
| FocalLengthRange | Describes the range of the focal length that the camera sensor |
| | can perceive in terms of ValueRangeType. Its default unit is |
| | millimeters (mm). |
| | NOTE The minValue and the maxValue in the |
| | SensorCapabilityBaseType are not used for this sensor. |
| ValueRangeType | Defines the range of the value that the sensor can perceive. |
| MaxValue | Describes the maximum value that the sensor can perceive. |
| MinValue | Describes the minimum value that the sensor can perceive. |
| ApertureRangeFlag | This field, which is only present in the binary representation, |
| | signals the presence of the ApertureRange element. A value |
| | of “1” means that this element is present and “0” means that |
| | this element is not present. |
| ApertureRange | Describes the range of the aperture that the camera sensor can |
| | perceive in terms of valueRangeType. |
| | NOTE The minValue and the maxValue in the |
| | SensorCapabilityBaseType are not used for this sensor. |
| ShutterSpeedRangeFlag | This field, which is only present in the binary representation, |
| | signals the presence of the ShutterSpeedRange element. A |
| | value of “1” means that this element is present and “0” means |
| | that this element is not present. |
| ShutterSpeedRange | Describes the range of the shutter speed that the camera sensor |
| | can perceive in terms of valueRangeType. Its default unit is |
| | seconds (sec). |
| | NOTE The minValue and the maxValue in the |
| | SensorCapabilityBaseType are not used for this sensor. |
| ISOSpeedRangeFlag | This field, which is only present in the binary representation, |
| | signals the presence of the ISOSpeedRange element. A value |
| | of “1” means that this element is present and “0” means that |
| | this element is not present. |
| ISOSpeedRange | Describes the range of ISO Speed based on ISO that the camera |
| | sensor can perceive in terms of valueRangeType. |
| | NOTE The minValue and the maxValue in the |
| | SensorCapabilityBaseType are not used for this sensor. |
| ExposureValueRangeFlag | This field, which is only present in the binary representation, |
| | signals the presence of the ExposureValueRange element. A |
| | value of “1” means that this element is present and “0” means |
| | that this element is not present. |
| ExposureValueRange | Describes the range of the exposure value that the camera |
| | sensor can perceive in terms of valueRangeType. |
| | NOTE The minValue and the maxValue in the |
| | SensorCapabilityBaseType are not used for this sensor. |
| VideoFlag | A value of “0” means that this camera sensor can only shoot |
| | still image. A value of “1” means that this camera sensor can |
| | record video. |
| SensorType | A value of “0” means that this camera sensor can only perceive |
| | monochrome image. A value of “1” means that this camera |
| | sensor can perceive color image. |
| ColorFilterArrayFlag | This field, which is only present in the binary representation, |
| | signals the presence of the ColorFilterArrayType element. A |
| | value of “1” means that this element is present and “0” means |
| | that this element is not present. |
| ColorFilterArrayType | Describes the color filter array applied to the image sensor of a |
| | camera |
| | 0000 Reserved |
| | 0001 Bayer |
| | 0010 RGBE |
| | 0011 CYYM |
| | 0100 CYGM |
| | 0101 RGBW Bayer |
| | 0110 RGBW #1 |
| | 0111 RGBW #2 |
| | 1000 RGBW #3 |
| | 1001-1111 Reserved |
| ColorSpaceFlag | This field, which is only present in the binary representation, |
| | signals the presence of the ColorSpaceType element. A value |
| | of “1” means that this element is present and “0” means that |
| | this element is not present. |
| ColorSpaceType | Describes the color space applied. |
| BitDepthRangeFlag | This field, which is only present in the binary representation, |
| | signals the presence of the BitDepthRange element. A value |
| | of “1” means that this element is present and “0” means that |
| | this element is not present. |
| BitDepthRange | Describes the range of the bit depth that the camera sensor can |
| | perceive in terms of valueRangeType. |
| | NOTE The minValue and the maxValue in the |
| | SensorCapabilityBaseType are not used for this sensor. |
| SpectrumRangeFlag | This field, which is only present in the binary representation, |
| | signals the presence of the SpectrumRange element. A value |
| | of “1” means that this element is present and “0” means that |
| | this element is not present. |
| SpectrumRange | Describes the spectrum range that the camera sensor can |
| | perceive in terms of valueRangeType. Its default unit is |
| | nanometer (nm). |
| | NOTE The minValue and the maxValue in the |
| | SensorCapabilityBaseType are not used for this sensor. |
| ThermalRangeFlag | This field, which is only present in the binary representation, |
| | signals the presence of the ThermalRange element. A value |
| | of “1” means that this element is present and “0” means that |
| | this element is not present. |
| ThermalRange | Describes the thermal response range that the camera sensor |
| | can perceive in terms of valueRangeType. Its default unit is |
| | Celsius (° C.). |
| | NOTE The minValue and the maxValue in the |
| | SensorCapabilityBaseType are not used for this sensor. |
| WhiteBalanceTempRangeFlag | This field, which is only present in the binary representation, |
| | signals the presence of the WhiteBalanceTempRange element. |
| | A value of “1” means that this element is present and “0” |
| | means that this element is not present. |
| WhiteBalanceTempRange | Describes the white balance temperature range that the camera |
| | sensor can perceive in terms of valueRangeType. Its default |
| | unit is Kelvin (K). |
| | NOTE The minValue and the maxValue in the |
| | SensorCapabilityBaseType are not used for this sensor. |
| WhiteBalanceTintFlag | This field, which is only present in the binary representation, |
| | signals the presence of the WhiteBalanceTintRange element. |
| | A value of “1” means that this element is present and “0” |
| | means that this element is not present. |
| WhiteBalanceTintRange | Describes the range of white balance tint value that the camera |
| | sensor can perceive in terms of valueRangeType. |
| | NOTE The minValue and the maxValue in the |
| | SensorCapabilityBaseType are not used for this sensor. |

*Sound

Followings provide sound transducer characteristics (microphone) for sound wave acquisition.

The table 19 and 20 show syntax for microphoneCapabilityType.

TABLE 19

<complexType name=″microphoneCapabilityType″>
<complexContent>
<extension base=″cidl:SensorCapabilityBaseType″>
<sequence>

| | |
|---|---|
| <element name=″micorphoneType” | type=″scdv:mcrophoneListType″ |

minOccurs=″0″/>

| | | |
|---|---|---|
| <element | name=″transcuderArrayType″ | type=″scdv:transducerArrayListType″ |

minOccurs=″0″/>

| <element name=″probtType″ type=″scdv:probeListType″ minOccurs=″0″/> | | |
|---|---|---|
| <element | name=″polarPatternType″ | type=″scdv:polarPatternListType″ |

minOccurs=″0″/>

| | | |
|---|---|---|
| <element | name=″frequencyRange″ | type=″scdv:frequencyRangeType″ |

minOccurs=″0″/>

<element name=″responseType″ type=″scdv:frequencyRangeType″ minOccurs=″0″/>
<element name=″pickSensitivity″ type=″float″ minOccurs=″0″/>

</sequence>
</extension>
</complexContent>
</complexType>
<simpleType name=″microphoneListType″>
<restriction base=″string″>
<enumeration value=″condenser″/>
<enumeration value=″dynamic″/>
<enumeration value=″ribbon″/>
<enumeration value=″carbon″/>
<enumeration value=″piezoelectric″/>
<enumeration value=″fiber optic″/>
<enumeration value=″laser″/>
<enumeration value=″liquied″/>
<enumeration value=″MEMS″/>
</restriction>
</simpleType>
<simpleType name=″transducerArrayListType″>
<restriction base=″string″>
<enumeration value=″single array″/>
<enumeration value=″linear array″/>
<enumeration value=″curvilinear″/>
<enumeration value=″phased″/>
<enumeration value=″annular″/>
<enumeration value=″matrix array″/>
<enumeration value=″MEMS″/>
</restriction>
</simpleType>
<simpleType name=″probeListType″>
<restriction base=″string″>
<enumeration value=″linear″/>
<enumeration value=″sector″/>
<enumeration value=″convex″/>
<enumeration value=″carbon″/>
<enumeration value=″trapezoid″/>
</restriction>
</simpleType>
<simpleType name=″polarPatternListType″>
<restriction base=″string″>
<enumeration value=″omnidirectional″/>
<enumeration value=″bi-directional″/>
<enumeration value=″subcardioid″/>
<enumeration value=″cardioid″/>
<enumeration value=″hypercardioid″/>
<enumeration value=″supercardioid″/>
<enumeration value=″shotgun″/>
</restriction>
</simpleType>
<complexType name=″frequencyRangeType″>
<sequence>
<element name=″minFrequency″ type=″float″/>

<element name=″maxFrequency″ type=″float″/>

</sequence>
</complexType>

TABLE 20

| | Number | |
|---|---|---|
| | of bits | Mnemonic |
| microphoneCapabilityType{ | | |
| microphoneTypeFlag | 1 | bslbf |
| transducerArrayFlag | 1 | bslbf |
| probeTypeFlag | 1 | bslbf |
| polarPatternTypeFlag | 1 | bslbf |
| frequencyRangeFlag | 1 | bslbf |
| frequencyResponseTypeFlag | 1 | bslbf |
| sensitivityFlag | 1 | bslbf |
| SensorCapabilityBase | | SensorCapabilityBaseType |
| if (microphoneTypeFlag == 1){ | | |
| microphoneType | | microphoneListType |
| } | | |
| if (transducerArrayFlag == 1){ | | |
| transducerArrayType | | trnasducerArrayListType |
| } | | |
| if (probeTypeFlag == 1){ | | |
| probeType | 4 | probeListType |
| } | | |
| if (polarPatternTypeFlag == 1){ | | |
| polarPattern | 4 | polarPatternListType |
| } | | |
| if (frequencyRangeFlag == 1){ | | |
| frequencyRange | | frequencyRangeType |
| } | | |
| if (responseTypeFlag == 1){ | | |
| responseFrequency | | frequencyRangeType |
| } | | |
| if (sensitivityFlag == 1){ | | |
| pickSensitivity | 32 | fsbf |
| } | | |
| microphoneListType { | | |
| microphoneType | 4 | bslbf |
| } | | |
| transducerArrayListType { | | |
| transducerArrayType | 4 | blsbf |
| } | | |
| probeListType { | | |
| probeType | 4 | blsbf |
| } | | |
| polarPatternListyType { | | |
| polarPattern | 4 | blsbf |
| } | | |
| frequencyRangeType { | | |
| minFrequency | 32 | uimsbf |
| maxFrequency | 32 | uimsbf |
| } | | |

The table 21 shows symantics for microphoneType.

TABLE 21

| Name | Definition |
|---|---|
| microphoneType | Defines type of microphone |
| | 0000 Reserved |
| | 0001 Condenser |
| | 0010 Dynamic |
| | 0011 Ribbon |
| | 0100 Carbon |
| | 0101 Piezoelectric |
| | 0110 Fiber Optic |
| | 0111 Laser |
| | 1000 Liquid |
| | 1001 MEMS |
| | 1010-1111 Reserved |
| transducerArrayType | Defines array types of transducer probes |
| | 0000 Reserved |
| | 0001 single array |
| | 0010 linear array |
| | 0011 curvilinear |
| | 0100 phased |
| | 0101 annular |
| | 0110 matrix array |
| | 0111-1111 Reserved |
| probeType | Defines probing type of transducer |
| | 0000 Reserved |
| | 0001 linear probe |
| | 0010 sector probe |
| | 0011 convex probe |
| | 0100 trapezoid probe |
| | 0101-1111 Reserved |
| polarPattern | Defines polar pattern of transducer |
| | 0000 Reserved |
| | 0001 Omnidirectional |
| | 0010 Bi-directional (or Figure of 8) |
| | 0011 Subcardioid |
| | 0100 Cardioid |
| | 0101 Hypercardioid |
| | 0110 Supercardioid |
| | 0111 Shotgun |
| | 1000-1111 Reserved |
| frequencyRange | Pickup frequency range in Hz |
| responseTypeFlag | ‘0’ if Flat frequency response |
| | ‘1’ if Tailored frequency response |
| responseFrequency | Pick response frequency range for tailored frequency response |
| | microphone |
| minFreqeuncy | Minimum frequency in Hz |
| maxFrequency | Maximum frequency in Hz |
| pickSensitivity | Pick sensitivity of transducer in mV/Pa |

This example of table 22 shows the description of a microphone capability with the following semantics. The microphone has an ID of “MCID_001”. It is a condenser microphone with cardioid pattern of which the frequency pick up range is 20 Hz-20 kHz tailored between 20 Hz-8 kHz.

TABLE 22

| | |
|---|---|
| <cidl:SensorDeviceCapability | xsi:type=“scdv:microphoneCapabilityType” |

id=“MCID_001”>

<microphoneType>“condenser”</microphoneType>
<polarPatternType>“cardioid”</polarPatternType>
<scdv:frequencyRange>

<scdv:minFrequency>20</scdv:minFrequency>
<scdv:maxFrequency>20000</scdv:maxFrequency>

</scdv:frequencyRange>
<scdv:responseType>

<scdv:minFrequency>20</scdv:minFrequency >
<scdv:maxFrequency >8000</scdv:maxFrequency >

</scdv:responseType>
</cidl:SensorDeviceCapability>

(3) Additional Sound Metadata for Media Orchestration

Depending on the application or input sound transducer type, the characteristics of captured sound are different. In order for an media processor successfully process acquired data, i.e., group, merge, separate, etc., more detailed metadata on transducer characteristics are necessary.

The rich information for media processor in terms of basic characteristics of the input sound transducer is provided.

The table 23 shows syntax for soundTransducerAttributes.

TABLE 23

| | Number | |
|---|---|---|
| | of bits | Mnemonic |
| soundTransducerAttributes { | | |
| transducerOrientationFlag | 1 | bslbf |
| transducerLocationFlag | 1 | bslbf |
| transducerTypeFlag | 1 | bslbf |
| transducerArrayFlag | 1 | bslbf |
| probeTypeFlag | 1 | bslbf |
| polarPatternTypeFlag | 1 | bslbf |
| frequencyRangeFlag | 1 | bslbf |
| frequencyResponseFlag | 1 | bslbf |
| sensitivityFlag | 1 | bslbf |
| if (transducerOrientationFlag == | | |

1){

| | | |
|---|---|---|
| transducerOrientation | See | OrientationSensorType |

above

}
if (transducerLocationFlag ==

1){

| transducerLocation | See | GlobalPositionSensorType |
|---|---|---|
| | above | |
| } | | |
| if (transducerTypeFlag == 1){ | | |
| transducerType | 4 | fsbf |
| } | | |
| if (transducerArrayFlag == 1){ | | |
| transducerArray | 4 | fsbf |
| } | | |
| if (probeTypeFlag == 1){ | | |
| probeType | 4 | fsbf |
| } | | |
| if (polarPatternTypeFlag == 1){ | | |
| polarPattern | 4 | fsbf |
| } | | |
| if (frequencyRangeFlag == 1){ | | |
| minFrequency | 24 | fsbf |
| maxFrequency | 24 | fsbf |
| } | | |
| if (frequencyResponseFlag == | | |

1){

| | | |
|---|---|---|
| minResponseFrequency | 24 | fsbf |
| maxResponseFrequency | 24 | fsbf |
| } | | |
| if (sensitivityFlag == 1){ | | |
| sensitivity | 8 | fsbf |
| } | | |

The table 24 shows symantics for soundTransducerAttributes.

TABLE 24

| Name | Definition |
|---|---|
| transducerOrientation | Defines direction of sound transducer |
| transducerLocation | Defines location of sound transducer |
| transducerType | Defines type of transducer |
| | 0000 Reserved |
| | 0001 Condenser |
| | 0010 Dynamic |
| | 0011 Ribbon |
| | 0100 Carbon |
| | 0101 Piezoelectric |
| | 0110 Fiber Optic |
| | 0111 Laser |
| | 1000 Liquid |
| | 1001 MEMS |
| | 1010-1111 Reserved |
| transducerArray | Defines array types of transducer probes |
| | 0000 Reserved |
| | 0001 single array |
| | 0010 linear array |
| | 0011 curvilinear |
| | 0100 phased |
| | 0101 annular |
| | 0110 matrix array |
| | 0111-1111 Reserved |
| probeType | Defines probing type of transducer |
| | 0000 Reserved |
| | 0001 linear probe |
| | 0010 sector probe |
| | 0011 convex probe |
| | 0100 trapezoid probe |
| | 0101-1111 Reserved |
| polarPattern | Defines polar pattern of transducer |
| | 0000 Reserved |
| | 0001 Omnidirectional |
| | 0010 Bi-directional (or Figure of 8) |
| | 0011 Subcardioid |
| | 0100 Cardioid |
| | 0101 Hypercardioid |
| | 0110 Supercardioid |
| | 0111 Shotgun |
| | 1000-1111 Reserved |
| minFrequency | Minimum pickup frequency in Hz |
| maxFrequency | Maximum pickup frequency in Hz |
| frequencyResponseFlag | ‘0’ if Flat frequency response |
| | ‘1’ if Tailored frequency response |
| minResponseFreqeuncy | Minimum Pick response frequency in Hz |
| maxResponseFrequency | Maximum Pick response frequency in Hz |
| sensitivity | Pick sensitivity of transducer in mV/Pa |

Depending on the characteristics of the transducers, media processor may be able to identify the purpose of captured sound wave and process accordingly. For example, if the transducer type is condenser with cardioid pattern of which the frequency range is 2-20 kHz tailored between 2-8 kHz, you may think that transducer(microphone) is for live vocals. Similarly, if the frequency range is 5 MHz-10 MHz, the transducer is used for diagnostics ultrasonic.

The table 25 shows symantics for microphoneSensorType.

TABLE 25

| | Number | |
|---|---|---|
| | of bits | Mnemonic |
| microphoneSensorType{ | | |
| microphoneGlobalPositionFlag | 1 | bslbf |
| microphoneLocalPositionFlag | 1 | bslbf |
| microphoneTypeFlag | 1 | bslbf |
| transducerArrayFlag | 1 | bslbf |
| probeTypeFlag | 1 | bslbf |
| polarPatternTypeFlag | 1 | bslbf |
| frequencyRangeFlag | 1 | bslbf |
| frequencyResponseTypeFlag | 1 | bslbf |
| sensitivityFlag | 1 | bslbf |
| SensedInfoBaseType | | SensedInfoBaseType |
| if | | |

(microphoneGlobalPositionFlag == 1){

| | |
|---|---|
| microphoneGlobalPosition | GlobalPositionSensorType |
| microphoneAltitude | AltitudeSensorType |
| microphoneOrientation | OrientationSensorType |
| } | |
| if (microphoneLocalPositionFlag | |

== 1){

| | | |
|---|---|---|
| microphoneLocalPositionFlag | | PositionSensorType |
| microphoneOrientation | | OrientationSensorType |
| } | | |
| if (microphoneTypeFlag == 1){ | | |
| microphoneType | | microphoneListType |
| } | | |
| if (transducerArrayFlag == 1){ | | |
| transducerArrayType | | trnasducerArrayListType |
| } | | |
| if (probeTypeFlag == 1){ | | |
| probeType | 4 | probeListType |
| } | | |
| if (polarPatternTypeFlag == 1){ | | |
| polarPattern | 4 | polarPatternListType |
| } | | |
| if (frequencyRangeFlag == 1){ | | |
| frequencyRange | | frequencyRangeType |
| } | | |
| if (responseTypeFlag == 1){ | | |
| responseFrequency | | frequencyRangeType |
| } | | |
| if (sensitivityFlag == 1){ | | |
| pickSensitivity | 32 | fsbf |
| } | | |
| microphoneListType { | | |
| microphoneType | 4 | bslbf |
| } | | |
| transducerArrayListType { | | |
| transducerArrayType | 4 | blsbf |
| } | | |
| probeListType { | | |
| probeType | 4 | blsbf |
| } | | |
| polarPatternListyType { | | |
| polarPattern | 4 | blsbf |
| } | | |
| frequencyRangeType { | | |
| minFrequency | 32 | uimsbf |
| maxFrequency | 32 | uimsbf |
| } | | |

The table 26 shows symantics for microphoneSensorType.

TABLE 26

| Name | Definition |
|---|---|
| microphoneGlobalPosition | Defines global positioning sensor based |
| | position information of microphone |
| microphoneAltitude | Defines altitude of microphone |
| microphoneOrientation | Defines orientation of microphone |
| microphoneLocalPosition | Defines relative location of microphone |
| transducerLocation | Defines location of sound transducer |
| microphoneType | Defines type of microphone |
| | 0000 Reserved |
| | 0001 Condenser |
| | 0010 Dynamic |
| | 0011 Ribbon |
| | 0100 Carbon |
| | 0101 Piezoelectric |
| | 0110 Fiber Optic |
| | 0111 Laser |
| | 1000 Liquid |
| | 1001 MEMS |
| | 1010-1111 Reserved |
| transducerArrayType | Defines array types of transducer probes |
| | 0000 Reserved |
| | 0001 single array |
| | 0010 linear array |
| | 0011 curvilinear |
| | 0100 phased |
| | 0101 annular |
| | 0110 matrix array |
| | 0111-1111 Reserved |
| probeType | Defines probing type of transducer |
| | 0000 Reserved |
| | 0001 linear probe |
| | 0010 sector probe |
| | 0011 convex probe |
| | 0100 trapezoid probe |
| | 0101-1111 Reserved |
| polarPattern | Defines polar pattern of transducer |
| | 0000 Reserved |
| | 0001 Omnidirectional |
| | 0010 Bi-directional (or Figure of 8) |
| | 0011 Subcardioid |
| | 0100 Cardioid |
| | 0101 Hypercardioid |
| | 0110 Supercardioid |
| | 0111 Shotgun |
| | 1000-1111 Reserved |
| frequencyRange | Pickup frequency range in Hz |
| responseTypeFlag | ‘0’ if Flat frequency response |
| | ‘1’ if Tailored frequency response |
| responseFrequency | Pick response frequency range for tailored |
| | frequency response microphone |
| minFreqeuncy | Minimum frequency in Hz |
| maxFrequency | Maximum frequency in Hz |
| pickSensitivity | Pick sensitivity of transducer in mV/Pa |

This example of table 27 show the description of a microphone capability with the following semantics. The microphone has an ID of “MCID_001”. It is a condenser microphone with cardioid pattern of which the frequency pick up range is 20 Hz-20 kHz tailored between 20 Hz-8 kHz.

TABLE 27

| | |
|---|---|
| <cidl:SensorDeviceCapability | xsi:type=“scdv:microphoneCapabilityType” |

id=“MCID_001”>

<microphoneType>“condenser”</microphoneType>
<polarPatternType>“cardioid”</polarPatternType>
<scdv:frequencyRange>

<scdv:minFrequency>20</scdv:minFrequency>
<scdv:maxFrequency>20000</scdv:maxFrequency>

</scdv:frequencyRange>
<scdv:responseType>

<scdv:minFrequency>20</scdv:minFrequency >
<scdv:maxFrequency >8000</scdv:maxFrequency >

</scdv:responseType>
</cidl:SensorDeviceCapability>

### The Second Embodiment

(1) Sensor Capability Description

Sensor capability of individual sensors is provided. The global coordinate for sensors which depends on the real world environment of user to determine the location of the sensors is defined. An abstract complex type of SensorCapabilityBaseType, which the sensor capability description of individual device should inherit.

(2) Global Coordinate for Sensors

The origin of the global coordinate for sensors is located at the position of the user adapting the right handed coordinate system. Each axis is defined as follows. Y-axis is in the direction of gravity. Z-axis is in the direction of the top right corner of the screen. X-axis is in the opposite direction of the user's position.

The table 28 shows syntax for SensorCapabilityBaseType.

TABLE 28

```
  <complexType name=″SensorCapabilityBaseType″ abstract=″true″>
  <complexContent>
```

<extension base=″dia:TerminalCapabilityBaseType″>

<sequence>

| | | |
|---|---|---|
| <element | name=″Accuracy″ | type=″cidl:AccuracyType″ |

minOccurs=“0″/>

</sequence>
<attributeGroup ref=″cidl:sensorCapabilityBaseAttributes″/>

</extension>

```
  </complexContent>
</complexType>
<complexType name=″AccuracyType″ abstract=″true″/>
<complexType name=″PercentAccuracy″>
  <complexContent>
```

<extension base=″cidl:AccuracyType″>

<attribute name=″value″ type=″mpeg7:zeroToOneType″/>

</extension>

```
  </complexContent>
</complexType>
<complexType name=″ValueAccuracy″>
  <complexContent>
```

<extension base=″cidl:AccuracyType″>

<attribute name=″value″ type=″float″/>

</extension>

</complexContent>
</complexType>

The table 29 shows syntax for SensorCapabilityBaseType.

TABLE 29

| | Number | |
|---|---|---|
| | of bits | Mnemonic |
| SensorCapabilityBaseType { | | |
| AccuracyFlag | 1 | bslbf |
| TerminalCapabilityBase | | TerminalCapabilityBaseType |
| if(AccuracyFlag){ | | |
| Accuracy | | AccuracyType |
| } | | |
| SensorCapabilityBaseAttributes | | SensorCapabilityBaseAttributesType |
| } | | |
| AccuracyType { | | |
| AccuracySelect | 2 | bslbf |

if(AccuracySelect==00){

| | | |
|---|---|---|
| PercentAccuracy | 32 | fsbf |

} else if (AccuracySelect==01) {

| | | |
|---|---|---|
| ValueAccuracy | 32 | fsbf |

}

}

The table 30 shows syntax for SensorCapabilityBaseType.

TABLE 30

| Name | Definition |
|---|---|
| SensorCapabilityBaseType | SensorCapabilityBaseType shall extend |
| | dia:TeminalCapabilityBaseType and provides a base |
| | abstract type for a subset of types defined as part of the |
| | sensor device capability metadata types. |
| AccuracyFlag | This field, which is only present in the binary |
| | representation, signals the presence of the activation |
| | attribute. A value of “1” means the attribute shall be used |
| | and “0” means the attribute shall not be used. |
| Accuracy | Describes the degree of closeness of a measured quantity to |
| | its actual value in AccuracyType. |
| sensorCapabilityBase Attributes | Describes a group of attributes for the sensor capabilities. |

The table 31 shows symantics for AccuracyType.

TABLE 31

| Name | Definition |
|---|---|
| AccuracyType | Becomes a parent type providing a choice of describing the |
| | accuracy in either relative value or absolute value. |
| AccuracySelect | This field, which is only present in the binary representation, |
| | describes which accuracy scheme shall be used. “0” means that |
| | the PercentAccuracy type shall be used, and “1” means that the |
| | ValueAccuracy type shall be used. |
| PercentAccuracy | Describes the degree of closeness of a measured quantity to its |
| | actual value in a relative way using a value ranging from 0 to 1.0. |
| value | Provides an actual value in a relative way for accuracy where |
| | value 0 means 0% accuracy and value 1.0 means 100% |
| | accuracy. It shall be a zeroToOneType type. |
| ValueAccuracy | Describes the degree of closeness of a measured quantity to its |
| | actual value in an absolute value of given unit. |
| Value | Provides an actual value in an absolute way, where the value |
| | means the possible range of error as (−value, +value) of given |
| | unit. |

The table 32 show syntax for sensorCapabilityBaseAttributes, and table 32 show syntax for SensorCapabilityBaseAttributesType.

TABLE 32
<attributeGroup name=“sensorCapabilityBaseAttributes”>

<attribute name=“unit” type=“mpegvct:unitType” use=“optional”/>
<attribute name=“maxValue” type=“float” use=“optional”/>
<attribute name=“minValue” type=“float” use=“optional”/>
<attribute name=“offset” type=“float” use=“optional”/>
<attribute name=“numOfLevels” type=“nonNegativeInteger”
use=“optional”/>
<attribute name=“sensitivity” type=“float” use=“optional”/>
<attribute name=“SNR” type=“float” use=“optional”/>

</attributeGroup>

TABLE 32

| | |
|---|---|
| Number | |
| of bits | Mnemonic |

SensorCapabilityBaseAttributesType

{

| | | |
|---|---|---|
| unitFlag | 1 | bslbf |

| | | |
|---|---|---|
| maxValueFlag | 1 | bslbf |
| minValueFlag | 1 | bslbf |
| offsetFlag | 1 | bslbf |
| numOfLevelsFlag | 1 | bslbf |
| sensitivityFlag | 1 | bslbf |
| SNRFlag | 1 | bslbf |
| if(unitFlag){ | | |
| unit | 8 | bslbf |

}

| | | |
|---|---|---|
| if(maxValueFlag){ | | |
| maxValue | 32 | fsbf |

}

| | | |
|---|---|---|
| if(minValueFlag){ | | |
| minValue | 32 | fsbf |

}

| | | |
|---|---|---|
| if(offsetFlag){ | | |
| offset | 32 | fsbf |

}

| | | |
|---|---|---|
| if(numOfLevelsFlag){ | | |
| numOfLevels | 16 | uimsbf |

}

| | | |
|---|---|---|
| if(sensitivityFlag){ | | |
| sensitivity | 32 | fsbf |

}

| | | |
|---|---|---|
| if(SNRFlag){ | | |
| SNR | 32 | fsbf |

}

}

The table 32 show symantics for SensorCapabilityBaseAttributes.

TABLE 32

| Name | Definition |
|---|---|
| sensorCapabilityBase | Describes a group of attributes for the sensor capabilities. |
| Attributes | |
| unitFlag | This field, which is only present in the binary representation, signals |
| | the presence of the activation attribute. A value of “1” means the |
| | attribute shall be used and “0” means the attribute shall not be used. |
| maxValueFlag | This field, which is only present in the binary representation, signals |
| | the presence of the activation attribute. A value of “1” means the |
| | attribute shall be used and “0” means the attribute shall not be used. |
| minValueFlag | This field, which is only present in the binary representation, signals |
| | the presence of the activation attribute. A value of “1” means the |
| | attribute shall be used and “0” means the attribute shall not be used. |
| offsetFlag | This field, which is only present in the binary representation, signals |
| | the presence of the activation attribute. A value of “1” means the |
| | attribute shall be used and “0” means the attribute shall not be used. |
| numOfLevelsFlag | This field, which is only present in the binary representation, signals |
| | the presence of the activation attribute. A value of “1” means the |
| | attribute shall be used and “0” means the attribute shall not be used. |
| sensitivityFlag | This field, which is only present in the binary representation, signals |
| | the presence of the activation attribute. A value of “1” means the |
| | attribute shall be used and “0” means the attribute shall not be used. |
| SNRFlag | This field, which is only present in the binary representation, signals |
| | the presence of the activation attribute. A value of “1” means the |
| | attribute shall be used and “0” means the attribute shall not be used. |
| unit | Describes the unit of the sensor's measuring value. |
| | Specifies the unit of the sensor's measuring value as a reference to a |
| | classification scheme term provided by UnitTypeCS, if a unit other |
| | than the default unit specified in the semantics of the maxValue and |
| | minValue is used for the values of maxValue and minValue are used. |
| maxValue | Describes the maximum value that the sensor can perceive. The |
| | terms will be different according to the individual sensor type. |
| minValue | Describes the minimum value that the sensor can perceive. The |
| | terms will be different according to the individual sensor type. |
| offset | Describes the number of value locations added to a base value in |
| | order to get to a specific absolute value. |
| numOfLevels | Describes the number of value levels that the sensor can perceive in |
| | between maximum and minimum value. |
| | EXAMPLE The value 5 means the sensor can perceive 5 steps |
| | from minValue to maxValue. |
| sensitivity | Describes the minimum magnitude of input signal required to |
| | produce a specified output signal in given unit. |
| SNR | Describes the ratio of a signal power to the noise power corrupting |
| | the signal. |

The following example of table 33 shows a use of SensorCapabilityBaseAttributes. It shows that an arbitrary sensor device of type any_specific_sensor_device_capability_type has an id of “ans01” with maxValue of 100, minValue of 10, 20 levels, offset of −3, sensitivity of 0.8, and SNR of 99 dB. It also shows that the measuring unit of the specified sensor device is dB.

TABLE 33

<cidl:SensorDeviceCapability xsi:type=
“scdv:any_specific_sensor_device_capability_type” id=“ans01”
maxValue=“100” minValue=“10” numOfLevels=“20” offset=“−3”
sensitivity=“0.8” SNR=“99” unit=“urn:mpeg:mpeg-v:01-CI-
UnitTypeCS-NS:dB”/>

*Camera Sensor Capability Type

The syntax and semantics of camera sensor capabilities are provided. This camera sensor capability supports the capapblities of the camera sensor, the spectrum camera sensor, the color camera sensor, the depth camera sensor, the stereo camera sensor, and the thermographic camera sensor.

The table 33 show syntax for CameraSensorCapabilityType.

TABLE 33
<complexType name=“CameraSensorCapabilityType”>
<complexContent>
<extension base=“cidl:SensorCapabilityBaseType”>
<sequence>

| | | |
|---|---|---|
| <element | name=“SupportedResolutions” | type=“scdv:ResolutionListType” |

minOccurs=“0”/>

| | | |
|---|---|---|
| <element | name=“FocalLengthRange” | type=“scdv:ValueRangeType” |

minOccurs=“0”/>

| <element name=“ApertureRange” type=“scdv:ValueRangeType” minOccurs=“0”/> | | |
|---|---|---|
| <element | name=“ShutterSpeedRange” | type=“scdv:ValueRangeType” |

minOccurs=“0”/>

| <element name=“ISOSpeedRange” type=“scdv:ValueRangeType” minOccurs=“0”/> | | |
|---|---|---|
| <element | name=“ExposureValueRange” | type=“scdv:ValueRangeType” |

minOccurs=“0”/>

| | | |
|---|---|---|
| <element | name=“ColorFilterArrayType” | type=“scdv:ColorFilterArrayListType” |

minOccurs=“0”/>

<element name=“Video” type=“boolean” minOccurs=“0”/>
<element name=“SensorType” type=“boolean” minOccurs=“0”/>

<element name=“ColorSpaceType” type=“string” minOccurs=“0”/>

| <element name=“BitDepthRange” type=“scdv:ValueRangeType” minOccurs=“0”/> | | |
|---|---|---|
| <element name=“SpectrumRange” type=“scdv:ValueRangeType” minOccurs=“0”/> | | |
| <element name=“ThermalRange” type=“scdv:ValueRangeType” minOccurs=“0”/> | | |
| <element | name=“WhiteBalanceTempRange” | type=“scdv:ValueRangeType” |

minOccurs=“0”/>

| | | |
|---|---|---|
| <element | name=“WhiteBalanceTintRange” | type=“scdv:ValueRangeType” |

minOccurs=“0”/>
</sequence>
</extension>
</complexContent>
</complexType>
<complexType name=“ResolutionListType”>
<sequence>

| | | |
|---|---|---|
| <element | name=“Resolution” | type=“scdv:ResolutionType” |

maxOccurs=“unbounded”/>
</sequence>
</complexType>
<complexType name=“ResolutionType”>
<sequence>
<element name=“Width” type=“nonNegativeInteger”/>

<element name=“Height” type=“nonNegativeInteger”/>

</sequence>
</complexType>
<complexType name=“ValueRangeType”>
<sequence>
<element name=“MaxValue” type=“float”/>

<element name=“MinValue” type=“float”/>

</sequence>
</complexType>
<simpleType name=“ColorFilterArrayListType”>
<restriction base=“string”>
<enumeration value=“Bayer”/>
<enumeration value=“RGBE”/>
<enumeration value=“CYYM”/>
<enumeration value=“CYGM”/>
<enumeration value=“RGB Bayer”/>
<enumeration value=“RGBW #1”/>
<enumeration value=“RGBW #2”/>
<enumeration value=“RGBW #3”/>
</restriction>
</simpleType>

The table 34 show syntax for CameraSensorCapabilityType.

TABLE 34

| | |
|---|---|
| Number | |
| of bits | Mnemonic |

CameraSensorCapabilityT

ype {

| | | |
|---|---|---|
| SupportedResolutionsFlag | 1 | bslbf |
| FocalLengthRangeFlag | 1 | bslbf |
| ApertureRangeFlag | 1 | bslbf |
| ShutterSpeedRangeFlag | 1 | bslbf |
| ISORangeFlag | 1 | bslbf |
| ExposureValueRangeFlag | 1 | bslbf |
| ColorFilterFlag | 1 | bslbf |
| VideoFlag | 1 | bslbf |
| SensorType | 1 | bslbf |
| ColorSpaceFlag | 1 | bslbf |
| BitDepthRangeFlag | 1 | bslbf |
| SpectrumRangeFlag | 1 | bslbf |
| ThermalRangeFlag | 1 | bslbf |
| WhiteBalanceTempRange | 1 | bslbf |

Flag

| | | |
|---|---|---|
| WhiteBalanceTintRangeF | 1 | bslbf |

lag

| | |
|---|---|
| SensorCapabilityBase | SensorCapabilityBaseType |
| if(SupportedResolutionsFl | |

ag) {

| | |
|---|---|
| SupportedResolutions | ResolutionListType |
| } | |
| if(FocalLengthRangeFlag | |

) {

| | |
|---|---|
| FocalLengthRange | ValueRangeType |
| } | |
| if(ApertureRangeFlag) { | |
| ApertureRange | ValueRangeType |
| } | |
| if(ShutterSpeedRangeFlag | |

) {

| | |
|---|---|
| ShutterSpeedRange | ValueRangeType |
| } | |
| if(ISOSpeedRangeFlag) { | |
| ISOSpeedRange | ValueRangeType |
| } | |
| if(ExposureValueRangeFl | |

ag) {

| ExposureValueRange | | ValueRangeType |
|---|---|---|
| } | | |
| if(ColorFilterArrayFlag) { | | |
| ColorFilterArrayType | | ColorFilterArray |
| | | ListType |
| } | | |
| if(ColorSpaceFlag) { | | |
| ColorSpaceTypeLength | | vluimsbf |
| ColorSpaceType | See ISO | UTF-8 |
| | 10646 | |
| } | | |
| if(BitDepthRangeFlag) { | | |
| BitDepthRange | | ValueRangeType |
| } | | |
| if(SpectrumRangeFlag) { | | |
| SpectrumRange | | ValueRangeType |
| } | | |
| if(ThermalRangeFlag) { | | |
| ThermalRange | | ValueRangeType |
| } | | |
| if(WhiteBalanceTempRan | | |

geFlag) {

| | |
|---|---|
| WhiteBalanceTempRange | ValueRangeType |
| } | |
| if(WhiteBalanceTintRang | |

eFlag) {

| | |
|---|---|
| WhiteBalanceTintRange | ValueRangeType |
| } | |
| } | |
| ResolutionListType { | |
| LoopResolution | vluimsbf |
| for(k=0;k< | |

LoopResolution;k++) {

| | | |
|---|---|---|
| Resolution[k] | | ResolutionType |
| } | | |
| } | | |
| ResolutionType { | | |
| Width | 32 | uimsbf |
| Height | 32 | uimsbf |
| } | | |
| ValueRangeType { | | |
| MaxValue | 32 | fsbf |
| MinValue | 32 | fsbf |
| } | | |

The table 35 show symantics for CameraSensorCapabilityType.

TABLE 35

| Name | Definition |
|---|---|
| CameraSensorCapabilityType | Tool for describing a camera sensor capability. |
| SupportedResolutionsFlag | This field, which is only present in the binary representation, |
| | signals the presence of the SupportedResolutions element. A |
| | value of “1” means that this element is present and “0” means |
| | that this element is not present. |
| SupportedResolutions | Describes a list of resolution that the camera can support. |
| ResolutionListType | Describes a type of the resolution list which is composed of |
| | ResolutionType element. |
| ResolutionType | Describes a type of resolution which is composed of Width |
| | element and Height element. |
| Width | Describes a width of resolution that the camera can perceive. |
| Height | Describes a height of resolution that the camera can perceive |
| FocalLengthRangeFlag | This field, which is only present in the binary representation, |
| | signals the presence of the FocalLengthRange element. A |
| | value of “1” means that this element is present and “0” means |
| | that this element is not present. |
| FocalLengthRange | Describes the range of the focal length that the camera sensor |
| | can perceive in terms of ValueRangeType. Its default unit is |
| | millimeters (mm). |
| | NOTE The minValue and the maxValue in the |
| | SensorCapabilityBaseType are not used for this sensor. |
| ValueRangeType | Defines the range of the value that the sensor can perceive. |
| MaxValue | Describes the maximum value that the sensor can perceive. |
| MinValue | Describes the minimum value that the sensor can perceive. |
| ApertureRangeFlag | This field, which is only present in the binary representation, |
| | signals the presence of the ApertureRange element. A value |
| | of “1” means that this element is present and “0” means that |
| | this element is not present. |
| ApertureRange | Describes the range of the aperture that the camera sensor can |
| | perceive in terms of valueRangeType. |
| | NOTE The minValue and the maxValue in the |
| | SensorCapabilityBaseType are not used for this sensor. |
| ShutterSpeedRangeFlag | This field, which is only present in the binary representation, |
| | signals the presence of the ShutterSpeedRange element. A |
| | value of “1” means that this element is present and “0” means |
| | that this element is not present. |
| ShutterSpeedRange | Describes the range of the shutter speed that the camera sensor |
| | can perceive in terms of valueRangeType. Its default unit is |
| | seconds (sec). |
| | NOTE The minValue and the maxValue in the |
| | SensorCapabilityBaseType are not used for this sensor. |
| ISOSpeedRangeFlag | This field, which is only present in the binary representation, |
| | signals the presence of the ISO SpeedRange element. A value |
| | of “1” means that this element is present and “0” means that |
| | this element is not present. |
| ISOSpeedRange | Describes the range of ISO Speed based on ISO that the |
| | camera sensor can perceive in terms of valueRangeType. |
| ExposureValueRangeFlag | This field, which is only present in the binary representation, |
| | signals the presence of the ExposureValueRange element. A |
| | value of “1” means that this element is present and “0” means |
| | that this element is not present. |
| ExposureValueRange | Describes the range of the exposure value that the camera |
| | sensor can perceive in terms of valueRangeType. |
| | NOTE The minValue and the maxValue in the |
| | SensorCapabilityBaseType are not used for this sensor. |
| VideoFlag | A value of “0” means that this camera sensor can only shoot |
| | still image. A value of “1” means that this camera sensor can |
| | record video. |
| SensorType | A value of “0” means that this camera sensor can only perceive |
| | monochrome image. A value of “1” means that this camera |
| | sensor can perceive color image. |
| ColorFilterArrayFlag | This field, which is only present in the binary representation, |
| | signals the presence of the ColorFilterArrayType element. A |
| | value of “1” means that this element is present and “0” means |
| | that this element is not present. |
| ColorFilterArrayType | Describes the color filter array applied to the image sensor of a |
| | camera |
| | 0000 Reserved |
| | 0001 Bayer |
| | 0010 RGBE |
| | 0011 CYYM |
| | 0100 CYGM |
| | 0101 RGBW Bayer |
| | 0110 RGBW #1 |
| | 0111 RGBW #2 |
| | 1000 RGBW #3 |
| | 1001-1111 Reserved |
| ColorSpaceFlag | This field, which is only present in the binary representation, |
| | signals the presence of the ColorSpaceType element. A value |
| | of “1” means that this element is present and “0” means that |
| | this element is not present. |
| ColorSpaceType | Describes the color space applied. |
| BitDepthRangeFlag | This field, which is only present in the binary representation, |
| | signals the presence of the BitDepthRange element. A value |
| | of “1” means that this element is present and “0” means that |
| | this element is not present. |
| BitDepthRange | Describes the range of the bit depth that the camera sensor can |
| | perceive in terms of valueRangeType. |
| | NOTE The minValue and the maxValue in the |
| | SensorCapabilityBaseType are not used for this sensor. |
| SpectrumRangeFlag | This field, which is only present in the binary representation, |
| | signals the presence of the SpectrumRange element. A value |
| | of “1” means that this element is present and “0” means that |
| | this element is not present. |
| SpectrumRange | Describes the spectrum range that the camera sensor can |
| | perceive in terms of valueRangeType. Its default unit is |
| | nanometer (nm). |
| | NOTE The minValue and the maxValue in the |
| | SensorCapabilityBaseType are not used for this sensor. |
| ThermalRangeFlag | This field, which is only present in the binary representation, |
| | signals the presence of the ThermalRange element. A value |
| | of “1” means that this element is present and “0” means that |
| | this element is not present. |
| ThermalRange | Describes the thermal response range that the camera sensor |
| | can perceive in terms of valueRangeType. Its default unit is |
| | Celsius (° C.). |
| | NOTE The minValue and the maxValue in the |
| | SensorCapabilityBaseType are not used for this sensor. |
| WhiteBalanceTempRangeFlag | This field, which is only present in the binary representation, |
| | signals the presence of the WhiteBalanceTempRange element. |
| | A value of “1” means that this element is present and “0” |
| | means that this element is not present. |
| WhiteBalanceTempRange | Describes the white balance temperature range that the camera |
| | sensor can perceive in terms of valueRangeType. Its default |
| | unit is Kelvin (K). |
| | NOTE The minValue and the maxValue in the |
| | SensorCapabilityBaseType are not used for this sensor. |
| WhiteBalanceTintFlag | This field, which is only present in the binary representation, |
| | signals the presence of the WhiteBalanceTintRange element. |
| | A value of “1” means that this element is present and “0” |
| | means that this element is not present. |
| WhiteBalanceTintRange | Describes the range of white balance tint value that the camera |
| | sensor can perceive in terms of valueRangeType. |
| | NOTE The minValue and the maxValue in the |
| | SensorCapabilityBaseType are not used for this sensor. |

This example of table 36 shows the description of a camera sensing capability with the following semantics. The camera sensor has an ID of “CSCID_001”. The sensor has a list of the supported resolutions, 1280×720 (width×height) and 1920×1080. The maximum focal length of the sensor is 100 (mm) and the minimum focal length is 5 (mm). The maximum aperture of the sensor is F1.4 and the minimum aperture is F8. The maximum shutter speed of the sensor is 1 (sec) and the minimum shutter speed is 0.001 (sec).

TABLE 36

| | |
|---|---|
| <cidl:SensorDeviceCapability | xsi:type=“scdv:CameraSensorCapabilityType” |

id=“CSCID_001”>

<scdv:SupportedResolutions>

<scdv:Resolution>

<scdv:Width>1280</scdv:Width>
<scdv:Height>720</scdv:Height>

</scdv:Resolution>
<scdv:Resolution>

<scdv:Width>1920</scdv:Width>
<scdv:Height>1080</scdv:Height>

</scdv:Resolution>

</scdv:SupportedResolutions>
<scdv:FocalLengthRange>

<scdv:MaxValue>100</scdv:MaxValue>
<scdv:MinValue>5</scdv:MinValue>

</scdv:FocalLengthRange>
<scdv:ApertureRange>

<scdv:MaxValue>1.4</scdv:MaxValue>
<scdv:MinValue>8</scdv:MinValue>

</scdv:ApertureRange>
<scdv:ShutterSpeedRange>

<scdv:MaxValue>1</scdv:MaxValue>
<scdv:MinValue>0.001/scdv:MinValue>

</scdv:ShutterSpeedRange>

</cidl:SensorDeviceCapability>

*Microphone Sensor Capability Type

The syntax and semantics of capability description for a microphone sensor is provided.

The table 37 shows syntax for MicrophoneSensorCapabilityType.

TABLE 37
<complexType name=“MicrophoneSensorCapabilityType”>
<complexContent>
<extension base=“cidl:SensorCapabilityBaseType”>
<sequence>

| | |
|---|---|
| <element name=“micorphoneType” | type=“scdv:mcrophoneListType” |

minOccurs=“0”/>

| | | |
|---|---|---|
| <element | name=“transcuderArrayType” | type=“scdv:transducerArrayListType” |

minOccurs=“0”/>

| <element name=“probtType” type=“scdv:probeListType” minOccurs=“0”/> | | |
|---|---|---|
| <element | name=“polarPatternType” | type=“scdv:polarPatternListType” |

minOccurs=“0”/>

| | | |
|---|---|---|
| <element | name=“frequencyRange” | type=“scdv:frequencyRangeType” |

minOccurs=“0”/>

<element name=“responseType” type=“scdv:frequencyRangeType” minOccurs=“0”/>
<element name=“pickSensitivity” type=“float” minOccurs=“0”/>

</sequence>
</extension>
</complexContent>
</complexType>
<simpleType name=“microphoneListType”>
<restriction base=“string”>
<enumeration value=“condenser”/>
<enumeration value=“dynamic”/>
<enumeration value=“ribbon”/>
<enumeration value=“carbon”/>
<enumeration value=“piezoelectric”/>
<enumeration value=“fiber optic”/>
<enumeration value=“laser”/>
<enumeration value=“liquied”/>
<enumeration value=“MEMS”/>
</restriction>
</simpleType>
<simpleType name=“transducerArrayListType”>
<restriction base=“string”>
<enumeration value=“single array”/>
<enumeration value=“linear array”/>
<enumeration value=“curvilinear”/>
<enumeration value=“phased”/>
<enumeration value=“annular”/>
<enumeration value=“matrix array”/>
<enumeration value=“MEMS”/>
</restriction>
</simpleType>
<simpleTypename=“probeListType”>
<restriction base=“string”>
<enumeration value=“linear”/>
<enumeration value=“sector”/>
<enumeration value=“convex”/>
<enumeration value=“carbon”/>
<enumeration value=“trapezoid”/>
</restriction>
</simpleType>
<simpleType name=“polarPatternListType”>
<restriction base=“string”>
<enumeration value=“omnidirectional”/>
<enumeration value=“bi-directional”/>
<enumeration value=“subcardioid”/>
<enumeration value=“cardioid”/>
<enumeration value=“hypercardioid”/>
<enumeration value=“supercardioid”/>
<enumeration value=“shotgun”/>
</restriction>
</simpleType>
<complexType name=“frequencyRangeType”>
<sequence>
<element name=“minFrequency” type=“float”/>

<element name=“maxFrequency” type=“float”/>

</sequence>
</complexType>

The table 38 shows syntax for MicrophoneSensorCapabilityType.

TABLE 38

| | |
|---|---|
| Number | |
| of bits | Mnemonic |

MicrophoneSensorCapabilityType
{

| | | |
|---|---|---|
| microphoneTypeFlag | 1 | bslbf |
| transducerArrayFlag | 1 | bslbf |
| probeTypeFlag | 1 | bslbf |
| polarPatternTypeFlag | 1 | bslbf |
| frequencyRangeFlag | 1 | bslbf |
| frequencyResponseTypeFlag | 1 | bslbf |
| sensitivityFlag | 1 | bslbf |
| SensorCapabilityBase | | SensorCapa- |

bilityBaseType

if (microphoneTypeFlag == 1){

| | |
|---|---|
| microphoneType | microphoneListType |

}
if (transducerArrayFlag == 1){

| | |
|---|---|
| transducerArrayType | trnasducerArrayListType |

}
if (probeTypeFlag == 1){

| | | |
|---|---|---|
| probeType | 4 | probeListType |

}
if (polarPatternTypeFlag == 1){

| | | |
|---|---|---|
| polarPattern | 4 | polarPatternListType |

}
if (frequencyRangeFlag == 1){

| | |
|---|---|
| frequencyRange | frequencyRangeType |

}
if (responseTypeFlag == 1){

| | |
|---|---|
| responseFrequency | frequencyRangeType |

}
if (sensitivityFlag == 1){

| | | |
|---|---|---|
| pickSensitivity | 32 | fsbf |

}

microphoneListType {

| | | |
|---|---|---|
| microphoneType | 4 | bslbf |
| } | | |

transducerArrayListType {

| | | |
|---|---|---|
| transducerArrayType | 4 | blsbf |
| } | | |

probeListType {

| | | |
|---|---|---|
| probeType | 4 | blsbf |
| } | | |

polarPatternListyType {

| | | |
|---|---|---|
| polarPattern | 4 | blsbf |
| } | | |

frequencyRangeType {

| | | |
|---|---|---|
| minFrequency | 32 | uimsbf |
| maxFrequency | 32 | uimsbf |
| } | | |

The table 39 shows syntax for microphoneType.

TABLE 39

| Name | Definition |
|---|---|
| microphoneType | Defines type of microphone |
| | 0000 Reserved |
| | 0001 Condenser |
| | 0010 Dynamic |
| | 0011 Ribbon |
| | 0100 Carbon |
| | 0101 Piezoelectric |
| | 0110 Fiber Optic |
| | 0111 Laser |
| | 1000 Liquid |
| | 1001 MEMS |
| | 1010-1111 Reserved |
| transducerArrayType | Defines array types of transducer probes |
| | 0000 Reserved |
| | 0001 single array |
| | 0010 linear array |
| | 0011 curvilinear |
| | 0100 phased |
| | 0101 annular |
| | 0110 matrix array |
| | 0111-1111 Reserved |
| probeType | Defines probing type of transducer |
| | 0000 Reserved |
| | 0001 linear probe |
| | 0010 sector probe |
| | 0011 convex probe |
| | 0100 trapezoid probe |
| | 0101-1111 Reserved |
| polarPattern | Defines polar pattern of transducer |
| | 0000 Reserved |
| | 0001 Omnidirectional |
| | 0010 Bi-directional (or Figure of 8) |
| | 0011 Subcardioid |
| | 0100 Cardioid |
| | 0101 Hypercardioid |
| | 0110 Supercardioid |
| | 0111 Shotgun |
| | 1000-1111 Reserved |
| frequencyRange | Pickup frequency range in Hz |
| responseTypeFlag | ‘0’ if Flat frequency response |
| | ‘1’ if Tailored frequency response |
| responseFrequency | Pick response frequency range for |
| | tailored frequency response microphone |
| minFreqeuncy | Minimum frequency in Hz |
| maxFrequency | Maximum frequency in Hz |
| pickSensitivity | Pick sensitivity of transducer in mV/Pa |

This example of table 40 shows the description of a microphone capability with the following semantics. The microphone has an ID of “MCID_001”. It is a condenser microphone with cardioid pattern of which the frequency picks up range is 20 Hz-20 kHz tailored between 20 Hz-8 kHz.

TABLE 40

| | |
|---|---|
| <cidl:SensorDeviceCapability | xsi:type=“scdv:microphoneCapabilityType” |

id=“MCID_001”>

<microphoneType>“condenser”</microphoneType>
<polarPatternType>“cardioid”</polarPatternType>
<scdv:frequencyRange>

<scdv:minFrequency>20</scdv:minFrequency>
<scdv:maxFrequency>20000</scdv:maxFrequency>

</scdv:frequencyRange>
<scdv:responseType>

<scdv:minFrequency>20</scdv:minFrequency >
<scdv:maxFrequency >8000</scdv:maxFrequency >

</scdv:responseType>
</cidl:SensorDeviceCapability>

*Sensed Information Description Tools

The sensor information acquired through each individual sensor is provided. Instances of following sensed information may be generated as an output of the sensors. The abstract complex type of SensedInfoBaseType is defined, which the sensed information types for each individual sensor should inherit.

*Global Coordinate for Sensors

The reference coordinate for sensors is defined adapting the right handed coordinate system. Each axis is defined as follows: Y-axis is in the direction of gravity; Z-axis is in the direction of user's front (in common sense) which is orthogonal to the y-axis; X-axis is in the direction of user's right side which is also orthogonal to both y-axis and z-axis. The default origin of the reference coordinate for sensors is the position of the user. The origin of the coordinate system differs depending on the type of the sensor.

The table 41 and table 42 shows syntax for Sensed information base type.

TABLE 41

| <!-- ################################################ --> | |
|---|---|
| <!-- Sensed information base type | --> |

<!-- ################################################ -->
<complexType name=“SensedInfoBaseType” abstract=“true”>
<sequence>

| | | |
|---|---|---|
| <element | name=“TimeStamp” | type=“mpegvct:TimeStampType” |

minOccurs=“0”/>

</sequence>
<attributeGroup ref=“iidl:sensedInfoBaseAttributes”/>

</complexType>

TABLE 42

| | Number | |
|---|---|---|
| | of bits | Mnemonic |
| SensedInfoBaseType{ | | |
| TimeStampFlag | 1 | bslbf |
| SensedInfoBaseAttributes | | SensedInfoBaseAttributes |
| | | Type |
| If(TimeStampFlag){ | | |
| TimeStamp | | TimeStampType |
| } | | |
| } | | |

The table 43 shows syntax for SensedInfoListType.

TABLE 43

| Name | Definition |
|---|---|
| SensedInfoBaseType | Provides the topmost type of the base type hierarchy which |
| | each individual sensed information can inherit. |
| sensedInfoBaseAttributes | Describes a group of attributes for the sensed information. |
| TimeStamp | Provides the time information at which the sensed information |
| | is acquired. There is a choice of selection among three timing |
| | schemes, which are absolute time, clocktick time, and delta of |
| | clock tick time. |
| TimeStampFlag | This field, which is only present in the binary representation, |
| | signals the presence of the TimeStamp element. A value of “1” |
| | means the element shall be used and “0” means the element |
| | shall not be used.’ |

The table 44 shows syntax for Sensed information base attributes and table 45 shows syntax for SensedInfoBaseAttributesType.

TABLE 44
<!-- ################################################### -->
<!-- Definition of Sensed Information Base Attributes -->
<!-- ################################################### -->
<attributeGroup name=“sensedInfoBaseAttributes”>
<attribute name=“id” type=“ID” use=“optional”/>
<attribute name=“sensorIdRef” type=“anyURI” use=“optional”/>
<attribute name=“linkedlist” type=“anyURI” use=“optional”/>
<attribute name=“groupID” type=“anyURI” use=“optional”/>
<attribute name=“activate” type=“boolean” use=“optional”/>
<attribute name=“priority” type=“nonNegativeInteger” use=“optional”
default=“0”/>
</attributeGroup>

TABLE 45

| | |
|---|---|
| Number | |
| of bits | Mnemonic |

SensedInfoBaseAttributesType

{

| idFlag | 1 | bslbf |
|---|---|---|
| sensorIdRefFlag | 1 | bslbf |
| linkedlistFlag | 1 | bslbf |
| groupIDFlag | 1 | bslbf |
| priorityFlag | 1 | bslbf |
| activateFlag | 1 | bslbf |
| If(idFlag) { | | |
| id | See ISO | UTF-8 |
| | 10646 | |
| } | | |
| if(sensorIdRefFlag) { | | |
| sensorIdRef | See ISO | UTF-8 |
| | 10646 | |
| } | | |
| if(linkedlistFlag) { | | |
| linkedlist | See ISO | UTF-8 |
| | 10646 | |
| } | | |
| if(groupIDFlag) { | | |
| groupID | See ISO | UTF-8 |

10646

}
If(priorityFlag) {

| | | |
|---|---|---|
| priority | 32 | uimsbf |

| | | |
|---|---|---|
| } | | |
| if(activateFlag) { | | |
| activate | 1 | bslbf |
| } | | |
| } | | |

The table 46 shows symantics for sensedInfoBase Attributes.

TABLE 46

| Name | Definition |
|---|---|
| sensedInfoBase Attributes | Describes a group of attributes for the commands. |
| id | Unique identifier for identifying individual sensed |
| | information. |
| sensorIdRef | References a sensor that has generated the information |
| | included in this specific sensed information. |
| linkedlist | Describes the multi-sensor structure that consists of a group of |
| | sensors in a way that each record contains a reference to the ID |
| | of the next sensor. |
| groupID | Identifier for a group multi-sensor structure to which this |
| | specific sensor belongs. |
| activate | Describes whether the sensor shall be activated. A value |
| | of “true” means the sensor shall be activated and “false” means |
| | the sensor shall be deactivated. |
| | In the binary representation, A value of “1” means the sensor |
| | shall be activated and “0” means the sensor shall be |
| | deactivated. |
| priority | Describes a priority for sensed information with respect to |
| | other sensed information sharing the same point in time when |
| | the sensed information becomes adapted. A value of one |
| | indicates the highest priority and larger values indicate lower |
| | priorities. The default value of the priority is one. If there are |
| | more than one sensed information with the same priority, the |
| | order of process can be determined by the Adaptation engine |
| | itself. |
| | NOTE The priority might be used to apply the sensed |
| | information on the virtual world object characteristics - |
| | defined within a group of sensors - according to the |
| | capabilities of the adaptation VR. |
| | EXAMPLE The adaptation RV processes the individual |
| | sensed information of a group of sensors according to their |
| | priority in descending order due to its limited capabilities. That |
| | is, the sensed information with the lower priority might get |
| | lost. |
| SensedInfoBaseAttributesType | Tool for describing sensed information base attributes. |
| IDFlag | This field, which is only present in the binary representation, |
| | signals the presence of the ID attribute. A value of “1” means |
| | the attribute shall be used and “0” means the attribute shall not |
| | be used. |
| sensorIdRefFlag | This field, which is only present in the binary representation, |
| | signals the presence of the sensor ID reference attribute. A |
| | value of “1” means the attribute shall be used and “0” means |
| | the attribute shall not be used. |
| linkedlistFlag | This field, which is only present in the binary representation, |
| | signals the presence of the linked list attribute. A value of |
| | “1” means the attribute shall be used and “0” means the |
| | attribute shall not be used. |
| groupIDFlag | This field, which is only present in the binary representation, |
| | signals the presence of the group ID attribute. A value of |
| | “1” means the attribute shall be used and “0” means the |
| | attribute shall not be used. |
| priorityFlag | This field, which is only present in the binary representation, |
| | signals the presence of the priority attribute. A value of |
| | “1” means the attribute shall be used and “0” means the |
| | attribute shall not be used. |
| activateFlag | This field, which is only present in the binary representation, |
| | signals the presence of the activation attribute. A value of |
| | “1” means the attribute shall be used and “0” means the |
| | attribute shall not be used. |

*Camera Sensor Type

A basic sensor type which senses based on a camera is provided. Various types of cameras, such as infrared cameras or spectrum cameras can be specified using this type of sensor.

The table 47 shows symantics for sensedInfoBase Attributes.

TABLE 47
<!-- ################################################ -->

| | |
|---|---|
| <!-- Camera Sensor Type | --> |

<!-- ################################################ -->
<complexType name=“CameraSensorType”>

<complexContent>

<extension base=“iidl:SensedInfoBaseType”>

<sequence>

| | | |
|---|---|---|
| <element | name=“CameraOrientation” | type=“siv:OrientationSensorType” |

minOccurs=“0”/>

| | | |
|---|---|---|
| <element | name=“CameraLocation” | type=“siv:GlobalPositionSensorType” |

minOccurs=“0”/>

| | | |
|---|---|---|
| <element | name=“CameraAltitude” | type=“siv:AltitudeSensorType” |

minOccurs=“0”/>

</sequence>

```
  <attribute name=“focalLength” type=“float” use=“optional”/>
  <attribute name=“aperture” type=“float” use=“optional”/>
  <attribute name=“shutterSpeed” type=“float” use=“optional”/>
  <attribute name=“filter” type=“mpeg7:termReferenceType” use=“optional”/>
</extension>
```

</complexContent>

</complexType>

The table 48 shows syntax for CameraSensorType.

TABLE 48

| | |
|---|---|
| Number | |
| of bits | Mnemonic |

CameraSensorType {

| CameraOrientationFlag | 1 | bslbf |
|---|---|---|
| CameraLocationFlag | 1 | bslbf |
| CameraAltitudeFlag | 1 | bslbf |
| focalLengthFlag | 1 | bslbf |
| apertureFlag | 1 | bslbf |
| shutterSpeedFlag | 1 | bslbf |
| filterFlag | 1 | bslbf |
| SensedInfoBaseType | See above | SensedInfoBaseType |
| if (CameraOrientationFlag){ | | |
| CameraOrientation | See above | OrientationSensorType |
| } | | |
| if (CameraLocationFlag){ | | |
| CameraLocation | See above | GlobalPositionSen- |
| | | sorType |
| } | | |
| if (CameraAltitudeFlag){ | | |
| CameraAltitude | See above | AltitudeSensorType |
| } | | |
| if (focalLengthFlag){ | | |
| focalLength | 32 | fsbf |
| } | | |
| if (apertureFlag){ | | |
| Aperture | 32 | fsbf |
| } | | |
| if (shutterSpeedFlag){ | | |
| shutterSpeed | 32 | fsbf |
| } | | |
| if (filterFlag){ | | |
| Filter | 4 | bslbf |
| } | | |
| } | | |

The table 49 shows symantics for CameraSensorType.

TABLE 49

| Name | Definition |
|---|---|
| CameraSensorType | Tool for describing sensed information with respect to a |
| | camera sensor. |
| CameraLocation | Describes the location of a camera using the structure defined |
| | by GlobalPositionSensorType. |
| CameraAltitude | Describes the altitude of a camera using the structure defined |
| | by AltitudeSensorType. |
| CameraOrientation | Describes the orientation of a camera using the structure |
| | defined by OrientationSensorType. |
| focalLength | Describes the distance between the lens and the image sensor |
| | when the subject is in focus, in terms of millimeters (mm). |
| aperture | Describes the diameter of the lens opening. It is expressed as |
| | F-stop, e.g. F2.8. It may also be expressed as f-number |
| | notation such as f/2.8. |
| shutterSpeed | Describes the time that the shutter remains open when taking a |
| | photograph in terms of seconds (sec). |
| filter | Describes kinds of camera filters as a reference to a |
| | classification scheme term that shall be using the mpeg73. The |
| | CS that may be used for this purpose is the |
| | CameraFilterTypeCS. |
| CameraOrientationFlag | This field, which is only present in the binary representation, |
| | signals if camera orientation sensed information is available. A |
| | value of “1” indicates that the sensed information shall be |
| | included and “0” indicates that the sensed information shall not |
| | be included. |
| CameraLocationFlag | This field, which is only present in the binary representation, |
| | signals if camera location sensed information is available. A |
| | value of “1” indicates that the sensed information shall be |
| | included and “0” indicates that the sensed information shall not |
| | be included. |
| CameraAltitudeFlag | This field, which is only present in the binary representation, |
| | signals if camera altitude sensed information is available. A |
| | value of “1” indicates that the sensed information shall be |
| | included and “0” indicates that the sensed information shall not |
| | be included. |
| focalLengthFlag | This field, which is only present in the binary representation, |
| | signals the presence of focal length attribute. A value of “1” |
| | means the attribute shall be used and “0” means the attribute |
| | shall not be used. |
| apertureFlag | This field, which is only present in the binary representation, |
| | signals the presence of aperture attribute. A value of “1” means |
| | the attribute shall be used and “0” means the attribute shall not |
| | be used. |
| shutterSpeedFlag | This field, which is only present in the binary representation, |
| | signals the presence of shutter speed attribute. A value of “1” |
| | means the attribute shall be used and “0” means the attribute |
| | shall not be used. |
| filterFlag | This field, which is only present in the binary representation, |
| | signals the presence of filter attribute. A value of “1” means the |
| | attribute shall be used and “0” means the attribute shall not be |
| | used. |

This example of table 50 shows the description of a camera sensing with the following semantics. The description has identifier of “CSID001”. The sensor shall be sensed at timestamp=“60000” where there are 100 clock ticks per second. The focal length of the sensor is 50 (mm) and the aperture is F2.8 and the shutter speed of the sensor is 1/250 (sec) and uses an UV filter. The location information of the camera sensor has 37.23 N of the latitude and 131.23 E of the longitude. The orientation information of the camera sensor has Ox=“2.0” (radian), Oy=“−0.5” (radian), and Oz=“1.0” (radian).

The table 50 shows symantics for CameraSensorType.

TABLE 50
<iidl:InteractionInfo>
<iidl:SensedInfoList>

| | | | |
|---|---|---|---|
| <iidl:SensedInfo | xsi:type=“siv:CameraSensorType” | id=“CSID001” | activate=“true” |

| | | | |
|---|---|---|---|
| focalLength=“50” | aperture=“2.8” | shutterSpeed=“0.004” | filter=“urn:mpeg:mpeg-v:01-SI- |

CameraFilterTypeCS-NS:UV”>
<iidl:TimeStamp xsi:type=“mpegvct:ClockTickTimeType” timeScale=“100” pts=“60000”/>
<siv:CameraOrientation xsi:type=“siv:OrientationSensorType” unit=“radian”>
<siv:Orientation>
<mpegvct:X>2.0</mpegvct:X>
<mpegvct:Y>−0.5</mpegvct:Y>
<mpegvct:Z>1.0</mpegvct:Z>
</siv:Orientation>
</siv:CameraOrientation>

| | | |
|---|---|---|
| <siv:CameraLocation | xsi:type=“siv:GlobalPositionSensorType” | longitude=“131.23” |

latitude=“37.23”/>
</iidl:SensedInfo>
</iidl:SensedInfoList>
</iidl:InteractionInfo>

*Microphone Sensor Type

Microphone Sensor Type specifies a device that is capable of sensing audio information. The sensing properties of the microphone sensor are specified in the microphone sensor capability type. The applications of the microphone sensor type may include systems where audio recognition is needed like navigation systems or home automation (intelligent) systems, AR applications, and others.

The table 51 and table 52 show syntax for microphone sensor type.

TABLE 51

<!--#################################### -->
<!--Definition of microphone sensor type -->
<!--#################################### -->
<complexType name=“MicrophoneSensorType”>

<complexContent>

<extension base=“iidl:SensedInfoBaseType”>

<sequence>

<element name=“Orientation” type=“siv:OrientationSensorType”
minOccurs=“0”/>
<element name=“Altitude” type=“siv:AltitudeSensorType”
minOccurs=“0”/>
<element name=“Location” type=“siv:GlobalPositionSensorType”
minOccurs=“0”/>

<element name=“AudioData”
type=“siv:RawAudioType”/>

</sequence>

</extension>

</complexContent>

</complexType>
<complexType name=“RawAudioType”>

<choice>

<element name=“AudioData16” type=“hexBinary”/>
<element name=“AudioData64” type=“base64Binary”/>

</choice>
<attribute name=“sample_rate” type=“unsignedint”/>
<attribute name=“byte_order” type=“ByteOrderType”/>
<attribute name=“sign” type=“SignType”/>
<attribute name=“resolution” type=“ResolutionType”/>

</complexType>
<simpleType name=“ByteOrderType”>

<restriction base=“string”>

<enumeration value=“LittleEndian”/>
<enumeration value=“BigEndian”/>

</restriction>

</simpleType>
<simpleType name=“SignType”>

<restriction base=“string”>

<enumeration value=“Signed”/>
<enumeration value=“Unsigned”/>

</restriction>

</simpleType>
<simpleType name=“ResolutionType”>

<restriction base=“mpeg7:unsignedByte”>

<enumeration value=“4”/>
<enumeration value=“8”/>
<enumeration value=“12”/>
<enumeration value=“16”/>
<enumeration value=“20”/>
<enumeration value=“24”/>
<enumeration value=“32”/>
<enumeration value=“48”/>
<enumeration value=“64”/>

</restriction>

</simpleType>

TABLE 52

| | Number | |
|---|---|---|
| | of bits | Mnemonic |
| MicrophoneSensorType { | | |
| OrientationFlag | 1 | bslbf |
| LocationFlag | 1 | bslbf |

| | | |
|---|---|---|
| sampleRateFlag | 1 | bslbf |
| resolutionFlag | 1 | bslbf |

| | |
|---|---|
| SensedInfoBase | SensedInfoBaseType |
| if(OrientationFlag) { | |

| | |
|---|---|
| Orientation | OrientationSen- |

sorType

}

If(LocationFlag) {

| | |
|---|---|
| Location | GlobalPositionSen- |

sorType

}

| | AudioData { | | |
|---|---|---|---|
| | If(sampleRateFlag) { | | |
| sample_rate_size | | | vluimsbf5 |
| | sample_rate | sam- | uimsbf |

ple_rate_size

}

| | | |
|---|---|---|
| byte_order | 1 | bslbf |
| sign | 1 | bslbf |

If(resolutionFlag) {

| | | |
|---|---|---|
| resolution | 4 | bslbf |

}

| | | |
|---|---|---|
| RawAudioDataSize | | vluimsbf5 |
| RawAudioData | RawAu- | bslbf |
| | dioDataSize*8 | |

}
}

The table 53 shows symantics for MicrophoneSensorType.

TABLE 53

| Name | Definition |
|---|---|
| MicrophoneSensorType | Tool for describing sensed information with respect to a |
| | microphone sensor. |
| OrientationFlag | This field, which is only present in the binary representation, |
| | signals the presence of Orientation element. A value of |
| | “1” means that the Orientation element exists in the binary |
| | representation and “0” means the Orientation element does not |
| | exist in the binary reprentation. |
| AltitudeFlag | This field, which is only present in the binary representation, |
| | signals the presence of Altitude element. A value of |
| | “1” means that the Altitude element exists in the binary |
| | representation and “0” means the Altitude element does not |
| | exist in the binary reprentation. |
| LocationFlag | This field, which is only present in the binary representation, |
| | signals the presence of Location element. A value of |
| | “1” means that the Location element exists in the binary |
| | representation and “0” means the Location element does not |
| | exist in the binary reprentation. |
| sampleRateFlag | This field, which is only present in the binary representation, |
| | signals the presence of sampleRate attribute in AudioData. A |
| | value of “1” means the attribute shall be used and “0” means |
| | the attribute shall not be used. |
| resolutionFlag | This field, which is only present in the binary representation, |
| | signals the presence of resolution attribute in AudioData. A |
| | value of “1” means the attribute shall be used and “0” means |
| | the attribute shall not be used. |
| Orientation | Describes the orientation of the microphone using the structure |
| | defined by OrientationSensorType. |
| Altitude | Describes the altitude of the microphone using the structure |
| | defined by AltitudeSensorType. |
| Location | Describes the location of the microphone using the structure |
| | defined by GlobalPositionSensorType. |
| AudioData16 | Holds binary audio data encoded as a textual string in base-16 |
| | format. |
| AudioData64 | Holds binary audio data encoded as a textual string in base-64 |
| | format. |
| sample_rate_size | This field which is only present in the binary representation, |
| | specifies the size of binary encoded reprentation of |
| | sample_rate attribute value in bits. |
| sample_rate | Sample rate is the number of samples of audio carried per |
| | second, measured in Hz. |
| byte_order | It tells how the data is stored with the most significant byte on |
| | one end or the other. When more than one byte is used to |
| | represent a PCM sample, the byte order (big endian vs. little |
| | endian) must be known. Due to the widespread use of little- |
| | endian Intel CPUs, little-endian PCM tends to be the most |
| | common byte orientation. |
| | The following table shall be used for binary representation, and |
| | this field should be specified in the binary representation. |

| | Binary | |
|---|---|---|
| | representation | |
| | (1 bit) | ByteOrderType |
| | 0 | LittleEndian |
| | 1 | BigEndian |
| (sign | It is not enough to know that a PCM sample is, for example, 8 | |
| | bits wide. Whether the sample is signed or unsigned is needed | |
| | to understand the range. If the sample is unsigned, the sample | |
| | range is 0 . . . 255 with a center point of 128. If the sample is | |
| | signed, the sample range is −128 . . . 127 with a center point of 0. | |
| | If a PCM type is signed, the sign encoding is almost always 2's | |
| | complement. In very rare cases, signed PCM audio is | |
| | represented as a series of sign/magnitude coded numbers. | |
| | This field should be present in binary representation and the | |
| | following table shall be used for binary representation. | |
| | Binary | |
| | representation | |
| | (1 bits) | SignType |
| | 0 | Signed |
| | 1 | Unsigned |

| | |
|---|---|
| resolution | This parameter specifies the amount of data used to represent |
| | each discrete amplitude sample. The most common values are |
| | 8 bits (1 byte), which gives a range of 256 amplitude steps, or |
| | 16 bits (2 bytes), which gives a range of 65536 amplitude |
| | steps. Other sizes, such as 12, 20, and 24 bits, are occasionally |
| | seen. Some king-sized formats even opt for 32 and 64 bits per |
| | sample. |
| Signed | Specifies that the raw audio data coming from the microphone |
| | sensor is stored as signed numbers. |
| Unsigned | Specifies that the raw audio data coming from the microphone |
| | sensor is stored as unsigned numbers. |
| BigEndian | It specifies that the audio data is stored in the Big Endian |
| | format: the most significant byte of a word in the smallest |
| | address and the least significant byte is stored in the largest |
| | address. |
| LittleEndian | It specifies that the audio data is stored in the Little Endian |
| | format: the least significant byte in the smallest address. |
| RawAudioDataSize | Describes the size of the RawAudioData in bytes. This field is |
| | only present in binary representation. |
| RawAudioData | Actual data holder for binary raw audio data, only in binary |
| | representation. The size of this field is given in |
| | RawAudioDataSize field. |

This example of table 54 shows the description of a microphone sensing with the following semantics. The sensor is located at (−10, 0, 25) and its orientation is (0.3 0.6 0 0.2). The audio data format is described as follows: the sampling rate is 8000 Hz, the byte_order is little endian, the values are signed, represented on 16 bits.

TABLE 54

<cidl:SensorDeviceCapability
xsi:type=“scdv:MircophoneSensorType”
id=“micsens01”>
<Orientation>0.3 0.6 0 0.2</Orientation>
<Location>−10 0 25</Location>

<AudioData>
<sample_rate>8000</sample_rate>
<byte_order>LittleEndian</byte_order>
<sign>Signed</sign>
<resolution>16</resolution>

</AudioData>
</cidl:SensorDeviceCapability>

According to example embodiments described herein, a converting procedure of sensor information between a real world and a virtual world is effectively performed by defining various sensor information obtained from a camera sensor, and a microphone sensor in the real.

According to example embodiments described herein, a converting procedure of sensor information between a real world and a virtual world is effectively performed by defining capability of a camera sensor, and a microphone sensor.

The components described in the example embodiments of the present disclosure may be achieved by hardware components including at least one of a digital signal processor (DSP), a processor, a controller, an application specific integrated circuit (ASIC), a programmable logic element such as a field programmable gate array (FPGA), other electronic devices, and combinations thereof. At least some of the functions or the processes described in the example embodiments of the present disclosure may be achieved by software, and the software may be recorded on a recording medium. The components, the functions, and the processes described in the example embodiments of the present disclosure may be achieved by a combination of hardware and software.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors. The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for processing sensor information between a real world and a virtual world, the method comprising:
acquiring first sensing information from a sensor of the real world;
converting the first sensing information into virtual world object characteristics applied to the virtual world or second sensing information applied to the virtual world; and
applying the virtual world object characteristics or the second sensor information into the virtual world,
wherein the sensor of the real world corresponds to sensor capability description,
wherein a global coordinate depends on environment of the real world is set to the sensor of the real world.

2. The method of claim 1, wherein the sensor of the real world includes a camera sensor,
wherein the camera sensor is defined by camera sensor capability type.

3. The method of claim 2, wherein the camera sensor capability type includes at least one of SupportedResolutionsFlag, SupportedResolutions, ResolutionListType, Width, Height, FocalLengthRangeFlag, FocalLengthRange, ValueRangeType, ApertureRangeFlag, ApertureRange, ShutterSpeedRangeFlag, ShutterSpeedRange, ISOSpeedRangeFlag, ISOSpeedRange, ExposureValueRangeFlag, ExposureValueRange, VideoFlag, SensorType, ColorFilterArrayFlag, ColorFilterArrayType, ColorSpaceFlag, ColorSpaceType, BitDepthRangeFlag, BitDepthRange, SpectrumRangeFlag, SpectrumRange, ThermalRangeFlag, ThermalRange, WhiteBalanceTempRangeFlag, WhiteBalanceTempRange, WhiteBalanceTintFlag, and WhiteBalanceTintRange.

4. The method of claim 1, wherein the sensor of the real world includes a microphone sensor,
wherein the microphone sensor is defined by microphone sensor capability type.

5. The method of claim 4, wherein the microphone sensor capability type includes at least one of microphoneType, transducerArrayType, probeType, polarPattern, frequencyRange, responseTypeFlag, responseFrequency, minFreqeuncy, maxFrequency, and pickSensitivity.

6. The method of claim 2, wherein the camera sensor is specified based on CameraSensorType,
wherein the CameraSensorType includes at least one of CameraLocation, CameraAltitude, CameraOrientation, focalLength, aperture, shutterSpeed, filter, CameraOrientationFlag, CameraLocationFlag, CameraAltitudeFlag, focalLengthFlag, apertureFlag, shutterSpeedFlag, and filterFlag.

7. The method of claim 4, wherein the microphone sensor is specified based on MicrophoneSensorType,
wherein the MicrophoneSensorType includes at least one of OrientationFlag, AltitudeFlag, LocationFlag, sampleRateFlag, resolutionFlag, Orientation, Altitude, Location, sample_rate_size, sample_rate, byte_order, sign, resolution, Signed, Unsigned, BigEndian, LittleEndian, RawAudioDataSize, and RawAudioData.

8. A non-transitory computer-readable media in a electronic device,
wherein the media records sensor information for a sensor of a real world to be applied to a virtual object of a virtual world,
wherein the sensor of the real world corresponds to a sensor capability description,
wherein a global coordinate depends on environment of the real world is set to the sensor of the real world.

9. The computer-readable media of claim 8, wherein the sensor of the real world includes a camera sensor,
wherein the camera sensor is defined by camera sensor capability type.

10. The computer-readable media of claim 9, wherein the camera sensor capability type includes at least one of SupportedResolutionsFlag, SupportedResolutions, ResolutionListType, Width, Height, FocalLengthRangeFlag, FocalLengthRange, ValueRangeType, ApertureRangeFlag, ApertureRange, ShutterSpeedRangeFlag, ShutterSpeedRange, ISOSpeedRangeFlag, ISOSpeedRange, ExposureValueRangeFlag, ExposureValueRange, VideoFlag, SensorType, ColorFilterArrayFlag, ColorFilterArrayType, ColorSpaceFlag, ColorSpaceType, BitDepthRangeFlag, BitDepthRange, SpectrumRangeFlag, SpectrumRange, ThermalRangeFlag, ThermalRange, WhiteBalanceTempRangeFlag, WhiteBalanceTempRange, WhiteBalanceTintFlag, and WhiteBalanceTintRange.

11. The computer-readable media of claim 8, wherein the sensor of the real world includes a microphone sensor,
wherein the microphone sensor is defined by microphone sensor capability type.

12. The computer-readable media of claim 11, wherein the microphone sensor capability type includes at least one of microphoneType, transducerArrayType, probeType, polarPattern, frequencyRange, responseTypeFlag, responseFrequency, minFreqeuncy, maxFrequency, and pickSensitivity.

13. The computer-readable media of claim 9, wherein the camera sensor is specified based on CameraSensorType,
wherein the CameraSensorType includes at least one of CameraLocation, CameraAltitude, CameraOrientation, focalLength, aperture, shutterSpeed, filter, CameraOrientationFlag, CameraLocationFlag, CameraAltitudeFlag, focalLengthFlag, apertureFlag, shutterSpeedFlag, and filterFlag.

14. The computer-readable media of claim 11, wherein the microphone sensor is specified based on MicrophoneSensorType,
wherein the MicrophoneSensorType includes at least one of OrientationFlag, AltitudeFlag, LocationFlag, sampleRateFlag, resolutionFlag, Orientation, Altitude, Location, sample_rate_size, sample_rate, byte_order, sign, resolution, Signed, Unsigned, BigEndian, LittleEndian, RawAudioDataSize, and RawAudioData.

15. A sensor information processing system comprising a media processor,
wherein the media processor is configured to:
acquire first sensing information from a sensor of the real world;
convert the first sensing information into virtual world object characteristics applied to the virtual world or second sensing information applied to the virtual world; and
apply the virtual world object characteristics or the second sensor information into the virtual world,
wherein the sensor of the real world corresponds to sensor capability description,
wherein a global coordinate depends on environment of the real world is set to the sensor of the real world.

16. The sensor information processing system of claim 15, wherein the sensor of the real world includes a camera sensor,
wherein the camera sensor is defined by camera sensor capability type.

17. The sensor information processing system of claim 15, wherein the sensor of the real world includes a microphone sensor,
wherein the microphone sensor is defined by microphone sensor capability type.

18. The sensor information processing system of claim 15, wherein the camera sensor is specified based on CameraSensorType.

19. The sensor information processing system of claim 15, wherein the microphone sensor is specified based on MicrophoneSensorType.
